(19) United States
(12) Patent Application Publication
(10) Pub. No.: US 2025/0286803 A1
(43) Pub. Date: Sep. 11, 2025

(54) Reliable Low Latency Data Delivery Using Erasure Codes and Feedback Over a Tunnel Interface

(71) Applicant: BitRipple, Inc., Berkeley, CA (US)

(72) Inventors: Michael George Luby, Berkeley, CA (US); Lorenz Christoph Minder, Evanston, IL (US)

(21) Appl. No.: 19/071,633

(22) Filed: Mar. 5, 2025

Related U.S. Application Data
(60) Provisional application No. 63/561,517, filed on Mar. 5, 2024.

(51) Int. Cl. H04L 43/0894; H04L 43/0823; H04L 43/0864

(52) U.S. Cl. CPC H04L 43/0894; H04L 43/0847; H04L 43/0864

(57) ABSTRACT

Transmitting one or more first data packet streams from one or more sources to one or more destinations with reliability of transmission might comprise configuring transmission of packets of the first data packet streams to a sender, receiving packets of the first data packet streams from the one or more sources, converting packets of the first data packet streams into packets of a second packet stream comprising erasure coded data generated from the packets of the first data packet streams, transmitting the second packet stream to a receiver, reliably converting packets of the second packet stream using erasure decoding into packets of the first data packet streams, and transmitting those packets to the one or more destinations, wherein the number of packets of the second packet stream generated and transmitted by the sender to ensure reliable conversion is based on feedback packets transmitted from the receiver to the sender.

### CROSS-REFERENCES TO PRIORITY AND RELATED APPLICATIONS

This application is a non-provisional of, and claims the benefit of and priority from, U.S. Provisional Patent Application No. 63/561,517 filed Mar. 5, 2024, entitled “Reliable Low Latency Data Delivery Using Erasure Codes and Feedback Over a Tunnel”, which is incorporated by reference herein, as if set forth in full in this document, for all purposes.

U.S. Pat. No. 11,863,317 B2, issued Jan. 2, 2024, entitled “Methods for Reliable Low Latency Data Delivery Using Erasure Codes and Feedback” (hereinafter “Luby I”) is incorporated by reference herein, as if set forth in full in this document, for all purposes.

### FIELD

The present disclosure generally relates to data transmission and reception, and more particularly to reliably low-latency data delivery using tunnel interfaces.

### BACKGROUND

Data transmission from a source to a destination might be done by having the source of the data provide the data to a sender (a device, software, or system that transmits data) which can then transmit the data over a network to a receiver (a device, software, or system that receives data from a network) and the receiver can then process what it receives to reconstruct (as needed) the data and provide it to the destination (a device, software, or system that consumes the data). Of some concern is reliability, in that the network might lose or distort some of the data in transit. There are several methods known to ensure reliability, in that the destination receives the data that the source sent, and the source obtains assurances that the data was very likely received correctly at the destination.

One approach to provide reliable data transport is the use of a Transmission Control Protocol (“TCP”). The TCP protocol is the prevalent method used to reliably deliver multimedia streaming data from content providers over the Internet. Using the TCP protocol, a sender sends data in packets and relies on retransmission of packets lost en route between a sender and receiver to ensure reliability of the data to be delivered. With retransmission-based protocols, there can be several round-trip times (RTTs) of delivery latency when packets are lost en route between the sender and receiver, since a retransmission-based protocol adds at least an RTT to the delivery latency of a packet each time the packet is lost en route, and the same packet can be lost more than once en route. This additional delivery latency is acceptable when delivery latency budgets are not tight, e.g., when RTTs are sub-second and when it is acceptable to deliver data with several seconds, or up to 30-40 seconds or more of latency. This is because the typical strategy to delivery multimedia streaming data over the Internet is to buffer ahead at the receiver, i.e., the playback time of the streaming data that is currently being displayed at the receiver is many seconds delayed from the playback time of the streaming data that the receiver is currently downloading, and all of the intervening data is stored in a buffer at the receiver to be ready for playback, so there is plenty of time to retransmit lost packets of streaming data before playback of the data. A strength of using TCP, and retransmission-based protocols in general, is that the minimal amount of bandwidth is used to deliver data reliably. This is often crucial, as bandwidth can be a scarce resource that should be used as sparingly as possible.

For some data streaming applications, where a source does not provide the sender the data to be sent far in advance of when it is needed at the destination, delivery latency, or simply “latency”, might be measured for some block of data by the time delay between the time when the first data of the block is made available to the sender to start processing and sending and the time when the receiver completes its reception and processing to output the block to the destination. That time period might include some time spent sending information from the receiver back to the sender to address lost or corrupted data as might be needed to complete recovery of the block of data.

With TCP-style retransmission, there can be long latencies. For some applications, such as online cloud gaming applications and metaverse-type applications and other interactive streaming applications, long latencies are unacceptable. A metaverse-type application might be an AR/VR/XR application for playing high-quality interactive games over the Internet, with avatars meeting and interacting in a volumetric-rich virtual world that feels realistic to end users. Having excessive delays in interaction would diminish the experience and since it can be interactive, it might not be possible to send all the needed data ahead of time. Thus, such applications might be designed to expect, or require, consistent ultra-low latency data delivery. At the same time, such applications might also be designed to expect, or require, efficient use of bandwidth, as much of the data to be sent with low latency is high-resolution data that can consume large amounts of bandwidth.

Retransmission-based solutions might not work well when reliable ultra-low latency delivery of data is required or expected and when there is any kind of packet loss. For one, retransmission-based solutions can result in a delivery latency that varies dramatically depending on the actual packet loss. For example, when a packet is lost en route, the receiver identifies the lost packet and sends a packet identifier of the lost packet in feedback to the sender so that the sender knows to retransmit the packet, which adds at least an RTT to the delivery time of the packet. If the packet is lost en route again when the sender retransmits the packet, then the receiver again identifies the lost packet and sends the packet identifier in feedback to the sender so that the sender can retransmit the packet again. Depending on the amount of packet loss between the sender and receiver, this process may repeat several times before the packet is delivered to the receiver, causing several round-trip times (RTTs) of data delivery latency. It can be shown that data delivery latency variability is inherent with retransmission-based solutions, thus it is difficult for retransmission-based solution to achieve consistently reliable ultra-low latency data delivery.

One approach to that problem is to send the original streaming data in packets and accept, or hide as well as possible, displayed artifacts when there is packet loss. Some versions of the webRTC protocol use this approach. This approach might provide a less-than-ideal end user experience when, for example, the data to be delivered is highly compressed multimedia, which typically displays noticeable artifacts when parts of the compressed data to be displayed is not received.

Another method is to use a forward error correction erasure code at a fixed code rate to protect against packet loss up to a specified amount over a specified duration of time. This method needlessly consumes bandwidth when there is little or no packet loss, whereas data is not reliably delivered when the amount packet loss exceeds the specified amount of packet loss protection over the specified duration of time. Yet another method is to use retransmission-based protocols. Retransmission-based protocols are often used for example for video-conferencing applications, and often suffice for video-conferencing applications in terms of latency and the quality of the video, and they are bandwidth efficient, but as described above they do not work as well for applications with very high data rates and when consistent ultra-low latency is a design requirement.

The ability to easily integrate a solution into existing deployments is a concern when providing consistent ultra-low latency reliable data delivery between clients and cloud services. This is because it can be difficult to introduce changes to existing services such as established cloud gaming services that have their configurations and protocols in place. Many services run on proprietary servers that are not designed to be able to easily integrate additional functionality. The networks that are used to deliver data between servers and client devices might be shared by many services, and thus not easily modified for to suit the needs of services. The client application software used within services is generally hard to modify, and it is not scalable to integrate a solution into each client application. Thus, improvements are needed for providing a solution that enables integration into deployments without requiring changes to existing servers, client applications, and networks.

Improvements are needed for providing consistent ultra-low latency reliable data delivery, minimizing, or reducing the bandwidth needed to deliver data, and allowing easy integration into existing deployments of applications, services, content servers, client devices, and networks.

### SUMMARY

A tunneling method and apparatus might be provided for transmitting one or more first data packet streams from one or more sources to one or more destinations with reliability of transmission by configuring, at the one or more sources, transmission of packets of the first data packet streams to a sender, receiving, at the sender, packets of the first data packet streams from the one or more sources, converting, at the sender, packets of the first data packet streams into packets of a second packet stream comprising erasure coded data generated from the packets of the first data packet streams, transmitting, at the sender, packets of the second packet stream to a receiver, reliably converting, at the receiver, packets of the second packet stream using erasure decoding into packets of the first data packet streams, and transmitting, at the receiver, packets of the first data packet streams to the one or more destinations, wherein the number of packets of the second packet stream generated and transmitted by the sender to ensure reliable conversion is based on feedback packets transmitted from the receiver to the sender.

The one or more sources and/or the one or more destinations might be configured to be aware of conversions between the first data packet streams and the second packet stream, or they might be unaware of the conversions.

The packets of the first data packet streams might vary in size and packets of the second data packet stream might each be the same size. The second packet stream might have packets that carry data derived from more than one of the packets of the first data packet streams and data derived from one of the packets of the first data packet streams might be used to generate more than one packet of the second packet stream. The number of packets in the first data packet streams might, or might not, be the same as the number of packets in the second packet stream.

A first portion of the data of a packet of the first data packet stream might be carried in a first packet of the second data packet stream and a second portion of the data of the packet of the first data packet stream might be carried in a second packet of the second data packet stream.

A first portion of the data of a packet of the second data packet stream might carry data of a first packet of the first data packet stream and a second portion of the data of the packet of the second data packet stream might carry data of a second packet of the first data packet stream.

Converting at the sender might comprise organizing, at the sender, the data of the packets of the first data packet streams into a sequence of one or more data blocks, each block having a block identifier associated therewith and each block carrying identifying information about the packets of the first data packet streams carried in the block, wherein the packets of the first data packet streams vary in size, and erasure encoding, at the sender, a data block of the one or more data blocks into a second sequence of packets for the data block, wherein packets of the second sequence of packets for the data block are interchangeable.

Reliably converting at the receiver might comprise associating, at the receiver, the packets of the second data packet stream with one or more data blocks, each block having a block identifier associated therewith, recovering, at the receiver, a data block of the one or more data blocks from packets associated with the data block from the second data packet stream using erasure decoding, wherein packets associated with a data block of the second data packet stream are interchangeable, and extracting, at the receiver, packets of the first data packet streams from a recovered data block using identify information included in the data block.

Transmitting one or more first data packet streams from one or more source devices to one or more destination devices might comprise configuring, at the one or more source devices, transmission of packets of the first data packet streams to a sender device, receiving, at the sender device, packets of the first data packet streams from the one or more source devices, converting, at the sender device, packets of the first data packet streams into packets of a second data packet stream comprising erasure coded data generated from the packets of the first data packet streams, transmitting, at the sender device, packets of the second data packet stream to a receiver device, reliably converting, at the receiver device, the packets of the second data packet stream into packets of the first data packet streams, and transmitting, at the receiver device, packets of the first data packet streams to the one or more destination devices, wherein the number of packets of the second data packet stream generated and transmitted by the sender device to ensure reliable conversion is based on feedback packets transmitted from the receiver device to the sender device.

At least one of the source devices and the sending device might be the same device. A source device and a sending device might be combined into a combined transmission unit.

At least one of the destination devices and the receiving device might the same device. A destination device and a receiving device might be combined into a combined reception unit.

In another method, of transmitting one or more first data packet streams from one or more sources to one or more destinations with reliability of transmission, wherein the explicit congestion notification (ECN) field in the IP packet headers of the packets of the first data packet stream are set to indicate ECN-Capable Transport (ECT), the method might comprise configuring, at the one or more sources, transmission of packets of the first data packet streams to a sender, receiving, at the sender, packets of the first data packet streams from the one or more sources, detecting, at the sender, if the needed transmission rate to support the current source arrival rate is larger than the current allowed transmission rate at the sender, modifying, at the sender, the explicit congestion notification field to indicate congestion experienced (CE) in packets of the first data packet streams indicating network congestion if the needed transmission rate to support the current source arrival rate is larger than the current allowed transmission rate at the sender, converting, at the sender, the modified packets of the first data packet streams into a second data packet stream comprising erasure coded data generated from the packets of the first data packet streams, transmitting, at the sender, packets of the second packet stream to the receiver, reliably converting, at the receiver, the received packets of the second data packet stream into packets of the first data packet streams, and transmitting, at the receiver, the packets of the first data packet streams to the destinations.

Transmitting at the receiver might comprise, detecting, at the receiver, if the needed transmission rate to support the current source arrival rate is larger than the current allowed transmission rate at the sender, modifying, at the receiver, the explicit congestion notification field to indicate congestion experienced (CE) in packets of the first data packet streams indicating network congestion if the needed transmission rate to support the current source arrival rate is larger than the current allowed transmission rate at the sender, and transmitting, at the receiver, the packets of the first data packet streams to the destinations.

In response to setting the explicit congestion notification (ECN) to indicate congestion experienced (CE), a destination device might provide feedback to a source device that might result in the source device decreasing its rate of sending data.

A method might be provided of, and apparatus for, receiving, at a sender, one or more first data packet streams from one or more sources, converting, at the sender, the packets of the first data packet streams into a second packet stream comprising erasure coded data generated from the packets of the first data packet streams, transmitting, at the sender, packets of the second packet stream to a receiver, reliably converting, at the receiver, the received packets of the second packet stream using erasure decoding into the first data packet streams, and transmitting, at the receiver, the first data packet streams to one or more destinations, wherein the number of packets of the second packet stream generated and transmitted by the sender to ensure reliable conversion is based on feedback packets transmitted from the receiver to the sender.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 is a block diagram illustrating a sending system and a receiving system for conveying data packet streams over a network, according to various embodiments.

FIG. 2 is a block diagram depicting a timer-based method for forming data blocks at a sending system according to various embodiments.

FIG. 3 is a block diagram depicting a sending system obtaining data packet streams and sending encoded data packets to a receiving system, according to various embodiments.

FIG. 4 is a block diagram depicting a receiving system receiving encoded packets from a sending system, providing feedback packets to the sending system, and outputting a data packet stream recovered from received encoded packets, according to various embodiments.

FIG. 5 illustrates an example data block as might be organized by a sending system for arriving packets of data packet streams, according to various embodiments.

FIG. 6 illustrates an example block state table as might be maintained by a sending system for a particular block of data being sent by the sending system, according to various embodiments.

FIG. 7 illustrates a snapshot of a state of packets transmission while a sending system is sending encoded data for a block, according to various embodiments.

FIG. 8 is a block diagram depicting marking data packets with a congestion experienced indicator at a sending system according to various embodiments.

FIG. 9 illustrates an example computer system memory structure as might be used in performing methods described herein, according to various embodiments.

FIG. 10 is a block diagram illustrating an example computer system upon which the systems illustrated in FIGS. 1 and 9 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Many of the elements described herein as having a particular function might be implemented with software, hardware, and/or firmware. In some implementations, the elements might be entirely implemented in software to be executed by existing hardware. An implementation might include a processor or other hardware capable of executing instructions, instruction memory containing instructions that implement described functions, as well as memory for working variables, program memory, and data memory that might hold data, such as packet data, while being processed, as well as maintaining state memory.

There are many reasons for sending data, such as multimedia data, between sources and destinations. In most cases, reliable delivery of this data delivery is of high importance, and in many cases, delivering the data consistently with tight latencies is an important consideration. For example, video and audio data may be delivered to client devices from servers deployed in the cloud in a gaming service, services such as Xbox Cloud Gaming and GeForce NOW, and it is of paramount importance that audio and video is delivered quickly and reliably from the cloud servers to the client devices in reaction to the game players gestures and commands operating client devices. In this example, reliable and quick delivery of data in both directions between the cloud servers and the client devices is important to provide a high-quality interactive gaming experience to end users. As other examples, sources may be a variety of other applications producing data packet streams, e.g., a video content provider application producing a packet stream from cloud servers to deliver a TV show to viewers watching the video on client devices, or a sports league application producing a live packet stream from cloud servers to allow viewers to watch football games. In this case, viewers sometimes want to skip to various points in the video, and thus quick and reliable delivery of video from the cloud server to a client device is important to provide a good experience to viewers. Another example is a Microsoft Teams™ video conference application producing a UDP packet for audio conferencing and a separate UDP packet stream for video conferencing. Other examples include teleoperation of drones, robots, automobiles, and trucks, delivering real-time data streams (e.g., telemetry data) from aircraft to the ground, remote collaboration, and supporting real-time digital twins.

A goal in many of these use cases is to reliably deliver a data stream with consistently minimal latency over networks that can experience packet loss, where the packet loss occurs due to a variety of causes, e.g., wireless network signal strength variations, intermittent congestion in router and switch and access point queues, and a variety of other issues. A common way to provide reliable data stream delivery over such networks is to rely on retransmission-based protocols, such as TCP, WebRTC, RTMP, QUIC, and other similar protocols. It is difficult for retransmission-based protocols to achieve reliable delivery of data streams with consistently minimal latency when there is packet loss in the network. This is because retransmission-based protocols send packets across the network several times (from sender to receiver and from receiver to sender) to recover from packet loss, where the number of traversals of the network depends on the amount and pattern of packet loss in the network. Sending packets across the network multiple times to recover from packet loss adds a variable amount of latency to the reliable delivery, and thus the delivery latency of packet streams varies as the packet loss conditions vary.

Another goal is to easily integrate a solution into existing deployments when providing consistent ultra-low latency reliable data delivery between clients and cloud services. This goal has been addressed in other contexts. For example, a Virtual Private Network (abbreviated to VPN) is a solution that provides secure and private data transport in a way that is easily integrated into existing deployments without changes to servers, client applications, or networks. For example, VPN application software (hereafter referred to as VPN app) is installed at a client device, which is configured to connect to a corresponding VPN server located in a secure location installed at a cloud server, for example, located in a service such as Microsoft Azure, Amazon Web Services (AWS), or Google Cloud Platform (GCP), or a privately operated server. A VPN tunnel can be established between the VPN app running at the client device and the VPN server running at the cloud server. Typically, such a VPN tunnel can be bidirectional in that data packets sent from a content server to the client device flow to the VPN server at the cloud server, through the VPN tunnel to the VPN app at the client device, and then on to their destination at the client device. Similarly, all data packets sent from the client device to a content server flow to the VPN app at the client device, through the VPN tunnel to the VPN server at the cloud server, and then on to their destination at the content server. The VPN app and the VPN server are configured so that all data packets that flow through the VPN tunnel in either direction are encrypted as they enter the VPN tunnel and are decrypted as they leave the VPN tunnel, thereby providing a secure and private data connection between the client and the Internet.

A VPN tunnel can be implemented such that it requires no changes to existing networks, applications, or content servers to integrate into deployments. A VPN app might be installed at the client device, which is configured to establish a connection with a VPN server deployed in the cloud at a cloud server. Then, network configuration at the client is used to ensure that the initial portion of the path for all (or a selected portion) of the data that flows from the client to Internet content servers is to the VPN app at the client through the VPN tunnel to the VPN server at a cloud server, and that the final portion of the path for all (or a selected portion) of the data that flows from Internet content servers to the client is to the VPN server at the cloud server through the VPN tunnel to the VPN app at the client device.

Various embodiments are described that enable interactive applications such as those described above. Herein, some of those embodiments are deemed to be Virtual Interactive Networks (“VINs”). These embodiments can provide methods and apparatus for reliably delivering data from a sender to a receiver over a network with low latency, such as a packet network, where the data is carried in packets that may be lost en route. Embodiments include senders and receivers. Where the senders and/or receivers operate with a VIN, they might be referred to as VIN senders or VIN receivers, respectively. Data packets that flow between a VIN sender and VIN receiver are said to flow through a VIN tunnel. An embodiment can include methods and apparatus for receiving, at a VIN sender, one or more first data packet streams from one or more sources. The sources may be different applications producing data packet streams of different types, e.g., a Netflix™ application producing a TCP packet stream for a video show, a Microsoft Teams™ application producing a UDP packet for audio conferencing and a separate UDP packet stream for video conferencing, an Xbox Cloud Gaming™ device producing a WebRTC packet stream, or a YouTube™ server producing a QUIC packet stream. These sources can be configured, through network management tools, to transmit these data packet streams to the VIN sender. The aggregate of all the data packet streams from all the sources that are concurrently being received by the VIN sender, hereafter referred to as the first data packet streams, are converted at the VIN sender into a second packet stream comprising erasure coded data generated from the packets of the first data packet streams. The packets of the second data packet stream are transmitted from the VIN sender to a VIN receiver. At the VIN receiver, the received packets of the second packet stream are converted using erasure decoding into the first data packet streams. Then, at the VIN receiver, the first data packet streams are transmitted to their one or more final destinations. As described in detail in Luby I, the number of packets of the second packet stream generated and transmitted by the VIN sender to ensure reliable conversion is based on feedback packets transmitted from the VIN receiver to the VIN sender.

Similar to a VPN, VIN application software (hereafter referred to as a “VIN app”) can be installed at a client device, which is configured to connect to a corresponding VIN server located in a secure location at a cloud server, for example, a cloud server located in a service such as the Microsoft Azure™ service, the Amazon Web Services™ (AWS™) services, or a Google Cloud Platform™ (GCP™), or a privately operated server. A VIN tunnel can be established between the VIN app at the client device and the VIN server at the cloud server. Like a VPN, such a VIN tunnel can be bidirectional in that data packets sent from a content server to the client device flow to the VIN server at the cloud server, through the VIN tunnel to the VIN app at the client device, and then on to their destination at the client device, using a VIN sender of the VIN server at the cloud server and a VIN receiver of the VIN app at the client device. Similarly, all data packets sent from the client device to a content server flow to the VIN app at the client device, through the VIN tunnel to the VIN server at the cloud server, and then on to their destination at the content server, using a VIN sender of the VIN app at the client device and a VIN receiver of the VIN server at the cloud server.

There can be many variants of a VIN tunnel. For example, endpoints of a VIN tunnel can be run at network elements, such as access points or routers. Endpoints of a VIN tunnel can be run on any type of server, or client device, or any other type of computing platform such as an embedded device, etc. The endpoints of a VIN tunnel can be any combination of devices. For example, one endpoint can be running on a network element and the other endpoint can be running on a private server.

### Devices

The method might comprise one or more source devices that are configured to transmit one or more first data packet streams to one or more destination devices, configuring the source devices to transmit the first data packet streams to a sender device, converting, at the sender device, the packets of the first data packet streams into a second data packet stream comprising erasure coded data generated from the packets of the first data packet streams, transmitting, at the sender device, packets of the second data packet stream to a receiver device, reliably converting, at the receiver device, the received packets of the second data packet stream into the first data packet streams, and transmitting, at the receiver device, the first data packet streams to the destination devices, wherein the number of packets of the second data packet stream generated and transmitted by the sender device to ensure reliable conversion is based on feedback packets transmitted from the receiver device to the sender device.

The method might further comprise at least one of the source devices and the sending device are the same device.

The method might further comprise the receiver device and at least one of the destination devices are the same device.

Converting Source Packets into Transmitted Packets

The method might comprise one or more sources that are configured to transmit one or more first data packet streams to one or more destinations, configuring the sources to transmit the first data packet streams to a sender, converting, at the sender, the packets of the first data packet streams into a second data packet stream, wherein the packets of the first data packet streams vary in size, wherein the packets of the second data packet stream are the same size, transmitting, at the sender, packets of the second data packet stream to a receiver, reliably converting, at the receiver, the received packets of the second data packet stream into the first data packet streams, and transmitting, at the receiver, the first data packet streams to the destinations.

The method might further comprise converting, at the sender, the packets of the first data packet streams into a second data packet stream, wherein a first portion of the data of a packet of the first data packet stream is carried in a first packet of the second data packet stream and a second portion of the data of the packet of the first data packet stream is carried in a second packet of the second data packet stream.

The method might further comprise converting, at the sender, the packets of the first data packet streams into a second data packet stream, wherein a first portion of the data of a packet of the second data packet stream carries data of a first packet of the first data packet stream and a second portion of the data of the packet of the second data packet stream carries data of a second packet of the first data packet stream.

Compressing as Part of Converting Source Packets into Transmitted Packets

The method might comprise one or more sources that are configured to transmit one or more first data packet streams to one or more destinations, configuring the sources to transmit the first data packet streams to a sender, converting, at the sender, the packets of the first data packet streams into a second data packet stream, wherein converting includes compressing data of the packets of the first data packet stream to form the data of the packets of the second data packet stream, transmitting, at the sender, packets of the second data packet stream to a receiver, reliably converting, at the receiver, the received packets of the second data packet stream into the first data packet streams, wherein converting includes decompressing data of the packets of the second data packet stream to form the data of the packets of the first data packet streams, and transmitting, at the receiver, the first data packet streams to the destinations.

The method might further comprise converting, at the sender, the packets of the first data packet streams into a second data packet stream, wherein converting includes compressing based on identifying a first data value carried in multiple packets of the first data packet stream and replacing these with a shorter corresponding second data value in the copies of these multiple packets carried in the packets of the second data packet stream.

The method might further comprise reliably converting, at the receiver, the received packets of the second data packet stream into the first data packet streams, wherein reliably converting includes identifying a first data value in the copies of the packets of the first data packet streams carried in the packets of the second data packet stream and replacing these with a longer corresponding second data value in the packets of the first data packet streams.

### Data Blocks

The method might further comprise obtaining the data of the one or more first data packet streams from one or more source sources at the sender, organizing, at the sender, the data of the first data packet streams into a sequence of one or more data blocks, each block having a block identifier associated therewith, encoding, at the sender, a data block of the one or more data blocks into a second sequence of packets for the data block, wherein the packets of the second sequence of packets for the data block are interchangeable, wherein the packets of the first data packet streams vary in size, wherein the packets of the second data packet stream are the same size.

The method might further comprise organizing, at the sender, data of the first data packet streams into a sequence of one or more data blocks, each block having a block identifier associated therewith, encoding, at the sender, a data block of the one or more data blocks into packets of the second data packet stream associated with the data block, wherein packets of the second data packet stream associated with the data block are interchangeable.

The method might further comprise including additional identifying data in a data block at the sender that identifies which data from which of the packets of which of the first data packet streams is carried in each portion of the data block.

The method might further comprise associating, at the receiver, the data of the second data packet stream with one or more data blocks, each block having a block identifier associated therewith, recovering, at the receiver, using erasure decoding a data block of the one or more data blocks from received packets associated with the data block from the second data packet stream, wherein packets associated with a data block of the second data packet stream are interchangeable.

### Data for Block Transmitted Before all Data for the Block is Received at Sender

The method might further comprise generating, at the sender, repair data from a data block using an erasure encoder, transmitting, at the sender, packets of the second data packet stream, carrying data from data blocks and repair data generated from those data block, to a receiver, wherein at least some packets of the second data packet stream carrying data of a data block are transmitted by the sender before all packets of the first data packet stream carrying data of the data block have been received at the sender, reliably converting, at the receiver, the received packets of the second packet stream into the first data packet streams, and transmitting, at the receiver, the first data packet streams to the destinations, wherein the number of packets of the second packet stream generated and transmitted by the sender to ensure reliable conversion is based on feedback packets transmitted from the receiver to the sender.

The method might further comprise organizing, at the sender, a data block of the sequence of data blocks wherein the data block contains data of a packet of a first data packet stream among the first data packet streams and the data block contains the data of a packet from a second data packet stream among the first data packet streams.

### Encryption and Decryption of Data Blocks

The method might further comprise organizing, at the sender, the data of the first data packet streams into a sequence of one or more data blocks, encrypting, at the sender, a data block of the one or more data blocks into an encrypted data block, each encrypted block having a block identifier associated therewith, encoding, at the sender, using erasure encoding an encrypted data block of the one or more encrypted data blocks into packets of the second packet stream associated with the data block, wherein packets of the second packet stream associated with the encrypted data block are interchangeable.

The method might further comprise associating, at the receiver, the data of the second data packet stream with one or more encrypted data blocks, each encrypted data block having a block identifier associated therewith, recovering using erasure decoding, at the receiver, an encrypted data block of the one or more encrypted data blocks from received packets associated with the encrypted data block from the second data packet stream, wherein packets associated with an encrypted data block of the second data packet stream are interchangeable, decrypting, at the receiver, a data block from an encrypted data block of the sequence of encrypted data blocks.

### Encryption of Packets

The method might comprise one or more sources that are configured to transmit one or more first data packet streams to one or more destinations, configuring the sources to transmit the first data packet streams to a sender, converting, at the sender, the packets of the first data packet streams into a second packet stream comprising erasure coded data generated from the packets of the first packet streams, using encryption, at the sender, to generate encrypted packets of a third packet stream from the packets of the second packet stream, transmitting, at the sender, encrypted packets of the third packet stream to a receiver, receiving, at the receiver, encrypted packets of the third data packet stream, using decryption, at the receiver, to recover packets of the second data packet stream from encrypted packets of the third data packet stream, reliably converting, at the receiver, the packets of the second packet stream into the first data packet streams using erasure decoding, and transmitting, at the receiver, the first data packet streams to the destinations, wherein the number of encrypted packets of the third packet stream generated and transmitted by the sender to ensure reliable conversion is based on feedback packets transmitted from the receiver to the sender.

### Compression of Data Blocks

The method might further comprise organizing, at the sender, the data of the first data packet streams into a sequence of one or more data blocks, compressing, at the sender, a data block of the one or more data blocks into a compressed data block, each compressed block having a block identifier associated therewith, encoding, at the sender, using erasure encoding a compressed data block of the one or more compressed data blocks into packets of the second packet stream associated with the data block, wherein packets of the second packet stream associated with the compressed data block are interchangeable.

The method might further comprise compressing, at the sender, a data block of the one or more data blocks into a compressed data block using a gzip compression algorithm.

The method might further comprise associating, at the receiver, the data of the second data packet stream with one or more compressed data blocks, each compressed data block having a block identifier associated therewith, recovering using erasure decoding, at the receiver, a compressed data block of the one or more compressed data blocks from received packets associated with the compressed data block from the second data packet stream, wherein packets associated with an compressed data block of the second data packet stream are interchangeable, decompressing, at the receiver, a data block from a compressed data block of the sequence of compressed data blocks.

The method might further comprise decompressing, at the receiver, a data block from a compressed data block using a gzip compression algorithm.

### Source and Destination Addresses and Ports

The method might comprise receiving, at a sender, one or more first data packet streams from one or more sources, wherein a destination address and a destination port is associated with each of the first data packet streams, converting, at the sender, the packets of the first data packet streams into a second packet stream comprising erasure coded data generated from the packets of the first packet streams, associating, at the sender, a second destination address and a second destination port with a receiver, transmitting, at the sender, packets of the second packet stream to the associated second destination address and second destination port of the receiver, reliably converting, at the receiver, the received packets of the second packet stream using erasure decoding into packets of the first data packet streams, and transmitting, at the receiver, packets of the first data packet streams to the associated destination addresses and associated destination ports, wherein the number of packets of the second packet stream generated and transmitted by the sender to ensure reliable conversion is based on feedback packets transmitted from the receiver to the sender from the receiver.

### Multiple Path Delivery

The method might comprise one or more sources that are configured to transmit one or more first data packet streams to one or more destinations, configuring the sources to transmit the first data packet streams to a sender, converting, at the sender, the packets of the first data packet streams into a second packet stream comprising erasure coded data generated from the packets of the first data packet streams, transmitting, at the sender, packets of the second packet stream to a receiver over multiple network paths between the sender and the receiver, reliably converting, at the receiver, the received packets of the second packet stream from the multiple network paths into the first data packet streams using erasure decoding, and transmitting, at the receiver, the first data packet streams to the destinations, wherein the number of packets of the second packet stream generated and transmitted by the sender to ensure reliable conversion is based on feedback packets transmitted from the receiver to the sender.

The method might further comprise the sender transmitting packets of the second packet stream over more than one network interface to the receiver.

The method might further comprise the receiver receiving packets of the second packet stream over more than one network interface from the sender.

### Selecting and Pairing a Sender Endpoint and a Receiver Endpoint

The method might comprise one or more sources that are configured to transmit one or more first data packet streams to one or more destinations, selecting and pairing, a sender among a plurality of senders with a receiver among a plurality of receivers, configuring the sources to transmit the first data packet streams to the sender, converting, at the sender, packets of the first data packet streams into a second data packet stream comprising erasure coded data generated from the packets of the first data packet streams, transmitting, at the sender, packets of the second packet stream to the receiver, reliably converting, at the associated receiver, received packets of the second packet stream into the first data packet streams, and transmitting, at the associated receiver, the first data packet streams to the destinations, wherein the number of packets of the second packet stream generated and transmitted by the sender to ensure reliable conversion at the associated receiver is based on feedback packets transmitted from the associated receiver to the sender.

The method might further comprise selecting and pairing a sender and a receiver based on the one or more sources and the one or more destinations.

### Sender Transmitting Different Streams to Different Receivers

The method might comprise one or more sources that are configured to transmit one or more first data packet streams to one or more destinations, configuring the sources to transmit the first data packet streams to a sender, partitioning, at the sender, packets of the one or more of the first data packet streams into a second data packet stream and a third data packet stream, associating, at the sender, a first receiver with the second data packet stream and a second receiver with the third data packet stream, converting, at the sender, packets of the second data packet stream into a fourth data packet stream comprising erasure coded data generated from the second data packet stream, converting, at the sender, packets of the third data packet stream into a fifth data packet stream comprising erasure coded data generated from the third data packet stream, transmitting, at the sender, packets of the fourth data packet stream to the first receiver, transmitting, at the sender, packets of the fifth data packet stream to the second receiver, reliably converting, at the first receiver, received packets of the fourth data packet stream into the second data packet stream, wherein the number of packets of the fourth packet stream generated and transmitted by the sender to ensure reliable conversion is based on feedback packets transmitted to the sender from the first receiver, reliably converting, at the second receiver, received packets of the fifth data packet stream into the third data packet stream, wherein the number of packets of the fifth packet stream generated and transmitted by the sender to ensure reliable conversion is based on feedback packets transmitted to the sender from the second receiver, transmitting, at the first receiver, the second data packet stream to destinations, and transmitting, at the first receiver, the third data packet stream to destinations.

The method might further comprise partitioning, at the sender, the packets of the one or more of the first data packet streams into a second data packet stream and a third data packet stream, wherein the partitioning is based on the destinations of the packets of the first data packet streams.

The method might further comprise associating, at the sender, a first receiver with the second data packet stream and a second receiver with the third data packet stream, wherein the associating is based on the destinations of the packets of the second data packet stream and the destination of the packets of the third data packet stream.

### Prioritizing Some Streams Over Others

The method might comprise one or more sources that are configured to transmit one or more first data packet streams to one or more destinations, configuring the sources to transmit the first data packet streams to a sender, partitioning, at the sender, the one or more of the first data packet streams into a second data packet stream and a third data packet stream, converting, at the sender, packets of the second data packet stream into a fourth data packet stream comprising erasure coded data generated from the second data packet stream, converting, at the sender, packets of the third data packet stream into a fifth data packet stream comprising erasure coded data generated from the third data packet stream, transmitting, at the sender, packets of the fourth data packet stream and packets of the fifth data packet stream to the receiver, wherein packets of the fourth data packet stream are transmitted with higher priority than packets of the fifth data packet stream, reliably converting, at the receiver, received packets of the fourth data packet stream into the second data packet stream and received packets of the fifth data packet stream into the third data packet stream, wherein the number of packets of the fourth and fifth data packet streams generated and transmitted by the sender is based on feedback packets transmitted to the sender from the receiver, wherein the fourth data packet stream is converted into the second data packet stream with higher reliability than the fifth data packet stream is converted into the third packet stream, transmitting, at the receiver, the second data packet stream and third data packet stream to the destinations.

The method might further comprise partitioning, at the send device, the one or more of the first data packet streams into multiple data packet streams of different priorities.

The method might further comprise priorities that are based on delivering data packet streams within a given latency budget or based on reliability of delivering all the packets of a data packet stream.

### Sender or Receiver Influencing Source Arrival Rate

The method might comprise one or more sources that are configured to transmit one or more first data packet streams to one or more destinations, configuring the sources to transmit the first data packet streams to a sender, determining, at the sender, which packets to receive from the one or more first data packet streams, converting, at the sender, the received packets of the first data packet streams into a second packet stream comprising erasure coded data generated from the packets of the first data packet streams, transmitting, at the sender, packets of the second packet stream to a receiver, reliably converting, at the receiver, the received packets of the second packet stream into the first data packet streams, and transmitting, at the receiver, the first data packet streams to the destinations, wherein the number of packets of the second packet stream generated and transmitted by the sender to ensure reliable conversion is based on feedback packets transmitted from the receiver to the sender.

The method might further comprise determining, at the sender, which packets to receive from the one or more first data packet streams based on the rate at which packets arrive to the sender from the one or more first data packet streams compared to the rate at which the sender transmits packets to the receiving device.

The method might further comprise determining, at the sender, not to receive at least some packets from the one or more first data packet streams if the rate at which packets arrive to the sender from the one or more first data packet streams is higher than the rate at which the sender transmits packets to the receiving device.

The method might further comprise determining, at the sender, delaying reception of at least some packets from the one or more first data packet streams if the rate at which packets arrive to the sender from the one or more first data packet streams is higher than the rate at which the sender transmits packets to the receiving device.

The method might further comprise sending, at the sender, a signal to the sources the rate at which the source device is able to receive packets from the one or more first data packet streams.

### Sender Control of Allowed Transmission Rate

The method might comprise one or more sources that are configured to transmit one or more first data packet streams to one or more destinations, configuring the sources to transmit the first data packet streams to a sender, converting, at the sender, the received packets of the first data packet streams into a second packet stream comprising erasure coded data generated from the packets of the first data packet streams, determining, at the sender, an allowed transmission rate, transmitting, at the sender, packets of the second packet stream to a receiver at a rate that is at or below the allowed transmission rate, reliably converting, at the receiver, the received packets of the second packet stream into the first data packet streams, and transmitting, at the receiver, the first data packet streams to the destinations, wherein the number of packets of the second data packet stream generated and the allowed transmission rate set by the sender is based on feedback packets transmitted from the receiver to the sender.

The method might further comprise transmitting, at the receiver, feedback to the sender that includes the number of packets from the second data packet stream lost in transmission between the sender and the receiver, setting, at the sender, the allowed transmission rate based on the feedback from the receiver.

The method might further comprise transmitting, at the receiver, feedback to the sender that includes the timing of received packets from the second data packet stream, setting, at the sender, the allowed transmission rate based on the feedback from the receiver.

The method might further comprise setting, at the sender, the allowed transmission rate of packets based on feedback received from a network interface.

The method might further comprise setting, at the sender, the allowed transmission rate based on a transmission rate parameter setting.

The method might further comprise setting, at the sender, the allowed transmission rate based on the arrival rate of packets at the sender of the one or more first data packet streams.

The method might further comprise setting, at the sender, the allowed transmission rate to at most twice the arrival rate at the sender of packets of the one or more first data packet streams.

### Sender Control of Allowed Transmission Rate Over Multiple Network Paths

The method might further comprise transmitting, at the sender, packets of the second data packet stream using multiple network paths between the sender and the receiver, setting, at the sender, the allowed transmission rate over each of the multiple network paths based on feedback packets transmitted from the receiver to the sender.

The method might further comprise transmitting, at the receiver, feedback to the sender that includes information about received packets of the second data packet stream over each of the multiple network paths between the sender and receiver, setting, at the sender, the allowed transmission rate over each of the multiple network paths to the receiver based on feedback from the receiver.

### Explicit Congestion Notification

The method might comprise one or more sources that are configured to transmit one or more first data packet streams to one or more destinations, configuring the sources to transmit the first data packet streams to a sender, converting, at the sender, the received packets of the first data packet streams into a second data packet stream comprising erasure coded data generated from the packets of the first data packet streams, setting, at the sender, the explicit congestion notification (ECN) field in the IP packet headers of the packets of the second data packet stream to indicate ECN-Capable Transport (ECT), transmitting, at the sender, packets of the second packet stream to a receiver, reliably converting, at the receiver, the received packets of the second packet stream into the first data packet streams, and transmitting, at the receiver, the first data packet streams to the destinations, wherein the number of packets of the second data packet stream generated and transmitted by the sender to ensure reliable conversion is based on feedback packets transmitted from the receiver to the sender.

The method might further comprise detecting, at the receiver, if packets of the second data packet stream received at the receiver had their ECN field modified to indicate congestion experienced (CE) by network elements indicating network congestion between the sender and the receiver, sending, at the receiver, feedback to the sender indicating that packets of the second data packet stream have been received by the receiver with their ECN field modified to indicate CE.

The method might further comprise setting, at the sender, the allowed transmission rate based on feedback from the receiver carrying information about which packets of the second data packet stream received at the receiver have had their ECN field modified to indicate congestion experienced (CE) by network elements indicating network congestion between the sender and the receiver.

### Explicit Congestion Notification-Transferred Between First and Second Data Packet Streams

The method might comprise one or more sources that are configured to transmit one or more first data packet streams to one or more destinations, wherein the explicit congestion notification (ECN) field in the IP packet headers of the packets of the first data packet stream are set to indicate ECN-Capable Transport (ECT), configuring the sources to transmit the first data packet streams to a sender, converting, at the sender, the received packets of the first data packet streams into a second data packet stream comprising erasure coded data generated from the packets of the first data packet streams, wherein the explicit congestion notification (ECN) field in the IP packet headers of the packets of the second data packet stream are set to indicate ECN-Capable Transport (ECT), transmitting, at the sender, packets of the second packet stream to a receiver, reliably converting, at the receiver, the received packets of the second data packet stream into the first data packet streams, detecting, at the receiver, if the ECN field of received packets of the second data packet stream have been modified to indicate congestion experienced (CE) by network elements between the sender and the receiver indicating network congestion, modifying, at the receiver, the explicit congestion notification field to indicate CE in packets of the first data packet stream if the explicit congestion notification field is set to CE in received packets of the second data packet stream from which the packets of the first data packet stream have been recovered, and transmitting, at the receiver, packets of the first data packet streams to their destinations.

The method might further comprise, at the sender, setting the explicit congestion notification (ECN) field in the IP packet headers of the packets of the second data packet stream to indicate ECN-Capable Transport (ECT) only if the explicit congestion notification (ECN) field in the IP packet headers of the packets of the first data packet streams is set to indicate ECN-Capable Transport (ECT).

The method might comprise one or more sources that are configured to transmit one or more first data packet streams to one or more destinations, wherein the explicit congestion notification (ECN) field in the IP packet headers of the packets of the first data packet stream are set to indicate ECN-Capable Transport (ECT), configuring the sources to transmit the first data packet streams to a sender, receiving, at the sender, packets of the first data packet streams, detecting, at the sender, if the needed transmission rate to support the current source arrival rate is larger than the current allowed transmission rate at the sender, modifying, at the sender, the explicit congestion notification field to indicate congestion experienced (CE) in packets of the first data packet streams indicating network congestion if the needed transmission rate to support the current source arrival rate is larger than the current allowed transmission rate at the sender, converting, at the sender, the modified packets of the first data packet streams into a second data packet stream comprising erasure coded data generated from the packets of the first data packet streams, transmitting, at the sender, packets of the second packet stream to the receiver, reliably converting, at the receiver, the received packets of the second data packet stream into packets of the first data packet streams, and transmitting, at the receiver, the packets of the first data packet streams to the destinations.

Transmitting at the receiver might comprise, detecting, at the receiver, if the needed transmission rate to support the current source arrival rate is larger than the current allowed transmission rate at the sender, modifying, at the receiver, the explicit congestion notification field to indicate congestion experienced (CE) in packets of the first data packet streams indicating network congestion if the needed transmission rate to support the current source arrival rate is larger than the current allowed transmission rate at the sender, and transmitting, at the receiver, the packets of the first data packet streams to the destinations.

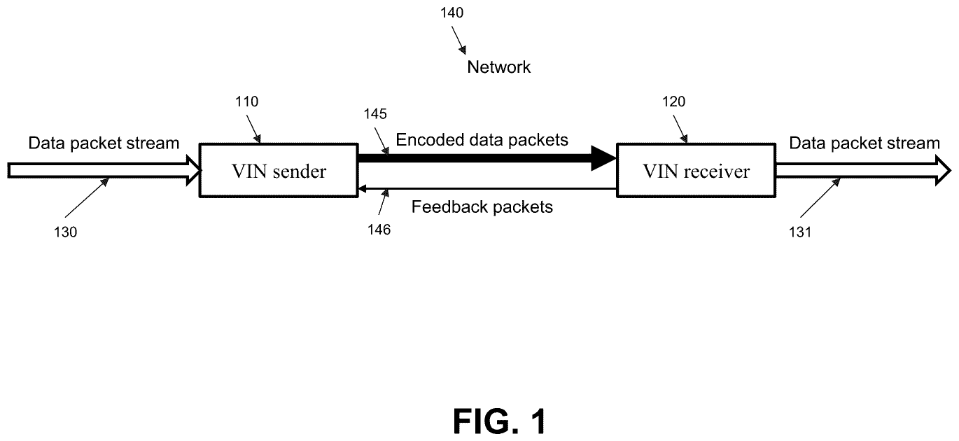

Referring now to the figures, FIG. 1 is an illustrative example of a VIN sender that (110) receives a data packet stream (130), converts, using erasure encoding, packets of the data packet stream into packets of an encoded packet stream (145) and transmits packets of the encoded packet stream over a network (140) to a VIN receiver (120). The VIN receiver converts received packets of the encoded packet stream into packets of the original data packet stream (131) and transmits these packets to their destinations. As shown, VIN receiver (120) sends feedback packets (146) to the VIN sender (110), wherein the feedback packets carry information that the VIN sender can use to adjust the amount of encoded data packets (145) to generate and transmit for each portion of the packets of the data packet stream (130) to ensure reliable conversion of the encoded data packets into the data stream at the VIN receiver.

### Devices

There are many different embodiments of the methods and apparatus described herein. For example, one or more services or applications may be deployed where one or more source devices are configured to transmit one or more first data packet streams to one or more destination devices. To provide the benefits of the methods and apparatus, the source devices may be configured to transmit the first data packet streams to a VIN sender device, wherein a VIN sender device is a hardware device with VIN sender software installed. According to the methods and apparatus described herein, the VIN sender device converts the packets of the first data packet streams into a second data packet stream comprising erasure coded data generated from the packets of the first data packet streams. The VIN sender device transmits packets of the second data packet stream to a VIN receiver device, wherein a VIN receiver device is a hardware device with VIN receiver software installed. The VIN receiver device reliably converts the received packets of the second data packet stream into the first data packet streams and transmits the first data packet streams to the destination devices. The number of packets of the second data packet stream generated and transmitted by the VIN sender device to ensure reliable conversion is based on feedback packets transmitted from the VIN receiver device to the VIN sender device.

In an embodiment, a VIN operates bidirectionally in that VIN software installed on a client device, and/or on a server, includes each of a VIN sender and a VIN receiver. Such a client device or server having such software might be referred to herein as a “VIN endpoint.” In some embodiments, a first VIN endpoint and a second VIN endpoint are paired for the purpose of transmitting data in both directions between the first and second VIN endpoints. For example, a client device with a VIN endpoint is paired with a server with a VIN endpoint, and thus data can be transmitted in both directions between these two VIN endpoints that are paired. This transmitting of data between two paired VIN endpoints might be referred to as transmitting data traffic through a VIN tunnel between the VIN endpoints. Similarly, data traffic can be transmitted in both directions through a VIN tunnel between two client devices with VIN endpoints, and data can be transmitted in both directions through a VIN tunnel between two servers with VIN endpoints.

The sources and a VIN sender may reside on the same device, or they may reside on different devices. Similarly, the destinations and a VIN receiver may reside on the same device, or they may reside on different devices. As an example, consider a cloud gaming service, where video and audio content is streamed from a game server to a client device with an installed gaming app that displays the received video and audio, and a gamer using the game app on the client device reacts in response to what is displayed and provides input commands that are streamed from the game app on the client device to the game server to determine the video stream the game server generates and send in response to the gamer input commands. In this example, a VIN tunnel is established between a VIN endpoint at the client device and a VIN endpoint at a cloud server, where the cloud server has good connectivity to the game server. For the input commands that are streamed from the game app on the client device to the game server, the sources (the gaming app at the client device) and the VIN sender reside on the same device, in this example the client device. For the video and audio content streamed from the game server to the game app at the client device, the sources (the game server) and the VIN sender reside on different devices, in this example the game server and the cloud server with the VIN endpoint. For the video and audio content streamed from the game server to the game app at the client device, the destinations and the VIN receiver reside on the same device, in this example the client device. For the input commands that are streamed from the game app on the client device to the game server, the destinations and the VIN receiver reside on different devices, in this example the game server and the cloud server with the VIN endpoint.

There may be one or more VIN endpoints that can run at the same time on a client device, or on a server. For example, in the cloud gaming service described above, there may be hundreds of VIN endpoints running at the same time at the same cloud server, and thus a single cloud server can concurrently support hundreds of client devices, where the client devices can be connected through a VIN tunnel to a variety of different Internet services, e.g., some of the client devices might be using the Xbox Cloud Gaming service, some may be using GeForce NOW service, some may be accessing YouTube content, some may be streaming live video from the NFL service, and some client devices may be themselves concurrently accessing multiple services at the same time.

Converting Source Packets into Transmitted Packets

The method might comprise one or more source devices that are configured to transmit one or more first data packet streams to one or more destinations, configuring the source devices to transmit the first data packet streams to a VIN sender. The packets of the first data packet streams are converted at the VIN sender into a second data packet stream, wherein the packets of the first data packet streams vary in size, wherein the packets of the second data packet stream are the same size. For example, the packets of the first data packet streams may comprise an audio packet stream, where the packets can be for example 40 bytes in size, and a video packet stream, where the packets can be for example 1280 bytes in size. The VIN sender converts the mix of these received packets from the audio and video streams into a second data packet stream, where for example packets are 1408 bytes in size. In one embodiment of this conversion process, the VIN sender concatenates the received packets of the first packet streams, and then forms packets of the second packet stream, where each packet of the second packet stream carries an equal number of consecutive bytes from the concatenated packets of the first packet streams.

For example, the concatenated packets of the first packet streams might comprise the concatenation of a first audio packet, a second audio packet, a first video packet, a second video packet, a third audio packet, a third video packet, and a fourth video packet, where all audio packets have size 40 bytes, all video packets have size 1280 bytes. Then, the first packet of the second packet stream comprises the first audio packet (bytes 0-39 of the first packet of the second packet stream), the second audio packet (bytes 40-79), the first video packet (bytes 80-1359), and the first 48 bytes of the second video packet (bytes 1360-1407), where packets of the second packet stream have size 1408 bytes in this example. The second packet of the second packet stream comprises the last 1230 bytes of the second video packet (bytes 0-1229), the third audio packet (bytes 1230-1269), and the first 138 bytes of the third video packet. The third packet of the second packet stream comprises the last 1142 bytes of the third video packet (bytes 0-1141), the first 266 bytes of the fourth video packet (bytes 1142-1407). Subsequent packets of the second packet stream carry the remainder of the fourth video packet and subsequent packets from the first packet streams.

In an embodiment, packets of the second packet stream can carry information that can be used at a VIN receiver to recover the first data packet streams from the received second data packet streams. For example, the packet headers of packets of the second data packet stream can carry information about the locations of the packets of the first packet streams they carry in their payloads. For example, a packet header of a packet of the second packet stream may include the number of different packets (including partial packets) from the first data packet streams carried in the packet payload of the packet of the second packet stream. The packet header may also include the starting positions of the carried packets of the first data packet stream in the packet payload.

In another embodiment, a packet of the second data packet stream may include packet boundary markers in its packet payload between the packets (or packet fragments) of the first data packet streams carried in its packet payload. For example, the boundary marker may be a fixed length string with a pattern that does not appear in any of the packets of the first data packet streams. As an example, the fixed length string could be 101111000010101011110110, if this is a bit sequence that does not appear in any of the packets of the first data packet streams.

Compressing as Part of Converting Source Packets into Transmitted Packets

To save on transmission bandwidth, a VIN sender can compress the data of the packets of the first data packet streams to form data of the packets of the second data packet stream. Correspondingly, a VIN receiver can decompress the received packets of the second data packet stream to recover the packets of the first data packet streams. As an example, the packets of the first data packet streams may all be being sent to the same destination IP address and same destination port number. Thus, a VIN sender may transmit the destination IP address and destination port number once to the VIN receiver, and then not include the destination IP address or destination port number in the copies of the packets of the first data packet streams carried in the payloads of the packets of the second data packet stream. At the VIN receiver, after extracting copies of packets of the first data packet streams from the payloads of received packets of the second data packet stream, the destination IP address and destination port number can be added to the copies to fully recover original packets of the first data packet streams. This same principle can be applied to compress other portions of packets of the first data packet streams in the process of converting to packets of the second data packet stream at a VIN sender, and to do the corresponding decompression at a VIN receiver.

In another embodiment of the methods and apparatus described herein, a VIN sender can use robust header compression (ROHC) techniques, such as those described in IETF RFC 3095, to reduce transmission bandwidth. The VIN sender can apply ROHC to the packet headers of packets of the first data packet streams to form header-compressed packets of the first data packet streams, and then the header-compressed packets of the first data packet streams are used to form data of the packets of the second data packet stream.

If there are multiple destination IP addresses and destination port numbers in the packets of the first data packet streams, then the VIN sender can replace the destination IP address and destination port number in packets of the first data packet streams with a corresponding short string that uniquely identifies the destination IP address and destination port number among the destination IP addresses and destination port numbers in packets of the first data packet streams, and the VIN sender can transmit the mapping information between destination IP addresses and destination port numbers and their corresponding short strings to the VIN receiver, and then the VIN sender can replace the destination IP address and destination port number with the corresponding short string in each packet of the first data packet streams to generate a shortened packet before converting the shortened packets into packets of the second data packet stream. At the VIN receiver, the procedure can be reversed: second data packets are converted into shortened packets of the first data packet streams, and then the shortened packets are converted into the original packets of the first data packet streams by replacing their short strings with their corresponding destination IP address and destination port number.

As another example, packets of the first data packet streams can be compressed at a VIN sender using a general compression algorithm such as gzip, and then the compressed packets of the first data packet streams are converted into packets of the second data packet streams using methods and apparatus described herein. Correspondingly, a VIN receiver can reliably convert packets of the second packet stream to recover compressed packets of the first data packet streams, and then use a general decompression algorithm to recover original packets of the first data packet streams from compressed packets of the first data packet streams.

### Data Blocks

The method might comprise obtaining the data of the one or more first data packet streams from one or more source sources at a VIN sender which organizes a sequence of one or more data blocks from the data packets of the first data packet streams. Each data block has an associated data block identifier (hereafter abbreviated to DBI), for example the data blocks are identified by consecutive integers with wraparound at a suitably larger number, e.g., the DBIs might be 0 through 2\hat{ }32−1, and thus each DBI can be represented as a 4-byte binary string. The VIN sender uses an erasure code, for example the RaptorQ™ code specified in IETF RFC 6330, to generate portions of encoded data from a data block using an erasure encoder, where preferably each encoded data portion is of the same size, for example 1408 bytes, where the size is chosen so that the encoded data portion can be carried in the packet payload of a packet sent across a network. Each encoded data portion is identified by an encoded data identifier (hereafter abbreviated to EDI), which identifies how the encoded data portion was generated from the data block. Herein, a packet carrying an encoded data portion might be referred to an encoded data packet. Encoded data packets generated from a data block are interchangeable in the sense that the original data block can be recovered using an erasure decoder from any set of sufficiently many encoded data packets, where “sufficiently many” can be defined as a value K. The value K can be equal to the data block size divided by the encoded data portion size (rounded up to the nearest integer). Generally, each encoded data packet includes the DBI, the value of K, and the EDI in the packet header, where the EDI identifies the encoded data portion carried in the packet payload.

Each data block is formed by concatenating packets of the first data packet streams, where the packets of the first data packet streams may vary in size. For example, the first data packet streams might comprise two first data packet streams, an audio data packet stream, and a video data packet stream, where all audio data packets have size 40 bytes, all video data packets have size 1280 bytes.

### Timer-Based Data Block Formation

A VIN sender might deploy a data block timer (“DB timer”) that the VIN sender might use for collecting received packets. The DB timer might have a DB timer duration that is some prespecified time duration from a time that the DB timer starts to a time when it expires. For example, the DB timer duration can be set to 5 milliseconds (ms), and thus the DB timer is said to expire 5 ms after it is started. The DB timer is started for a data block when the first packet of the data block to be formed arrives to the VIN sender. When the DB timer reaches the DB timer duration and thus the DB timer expires, the VIN sender completes the data block and initiates a next data block. The DB timer for the next data block starts at the time the first packet of the next data block arrives to the VIN sender, and so on. If the DB timer duration is set to 5 ms then all packets from the first data packet streams that arrive during the 5 ms period starting with the arrival of the first packet of the data block are concatenated to form the data block. For example, the packets of the first packet streams that arrive during the 5 ms period can be a first audio packet, a second audio packet, a first video packet, a second video packet, a third audio packet, a third video packet, and a fourth video packet. Then, the data block comprises the first audio packet (bytes 0-39 of the data bloc), the second audio packet (bytes 40-79), the first video packet (bytes 80-1359), the second video packet (bytes 1360-2639), the third audio packet (bytes 2640-2779), the third video packet (bytes 2780-4059), and the fourth video packet (bytes 4060-5339).

A VIN sender can also use a combination of timers to determine how to form data blocks. For example, the VIN sender can use a DB timer as described above in combination with a packet interarrival (PI) timer, with a corresponding DB timer duration and PI timer duration. The PI timer duration should be at most the DB timer duration. For example, the DB timer duration can be set to 5 ms and the PI timer duration can be set to 1 ms. As described above, the VIN sender starts the DB timer for a data block as soon as the first packet of the data block arrives to the VIN sender. The VIN sender restarts the PI timer each time a packet arrives at the VIN sender, and the PI timer is restarted each time another packet arrives at the VIN sender.

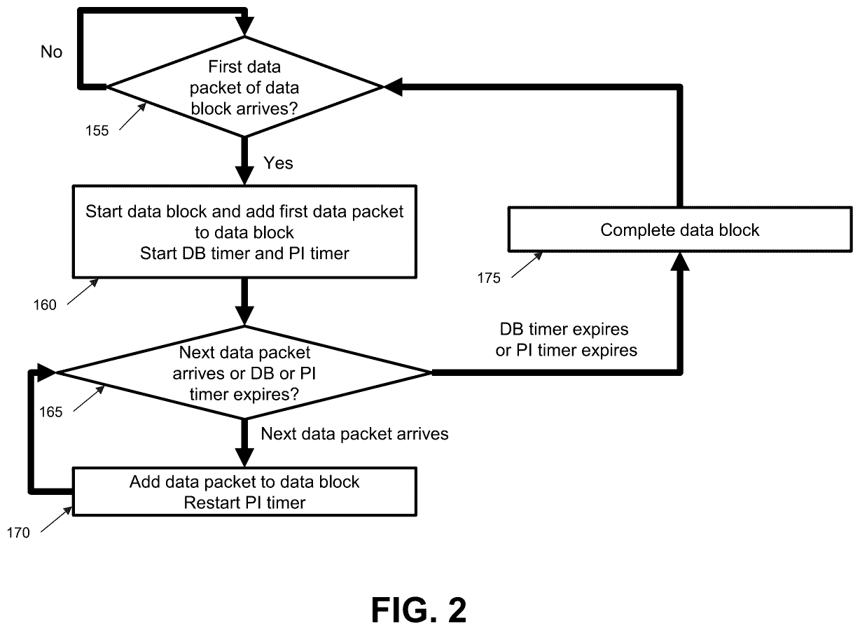

The method for forming data blocks based on the DB and PI timers can be described as follows, referring to FIG. 2. As soon as the first data packet of a data block to be formed arrives at the VIN sender (155) a new data block is started and the first data packet is added to the data block and the DB timer and PI timer are started (160). If either the DB timer or PI timer expires before the next data packet arrives at the VIN sender (165) then the data block is completed (170) and the VIN sender proceeds to wait for the arrival of the first packet of the next data block (155). On the other hand, if the next data packet arrives at the VIN sender before either the DB timer or PI timer expires (165) then the data packet is added to the data block and the PI timer is restarted (170), and the VIN sender waits for either the next data packet to arrive or one of the two timers to expire (165).

As an example, the DB timer duration can be set to 5 ms and the PI timer duration can be set to 1 ms. After the arrival of the first data packet for a data block, the data block is completed if there is a gap of at least 1 ms between subsequent packets arriving at the VIN sender, or if there is no such gap between packets then the data block is completed 5 ms after the first packet of the data block arrives at the VIN sender.

There are many benefits of the timer-based data block formation methods and embodiments described above. For example, for many interactive applications such as cloud gaming, cloud-rendered AR/VR, remote collaboration, packets arrive at a VIN sender in bursts over short intervals of time with longer intervals of times between bursts where no packets arrive at the VIN sender. It is advantageous to group a burst of packets into a single data block at the VIN sender, as it is more efficient for the VIN sender to protect large data blocks than smaller blocks with an erasure code, and it is also preferable that there is as little time as possible between when a data packet arrives at a VIN sender and when the VIN sender transmits encoded packets generated from a data block which carry information about the data packet. The timer-based methods and embodiments achieves both goals.

Furthermore, it is often the case that a burst of packets arriving at the VIN sender correspond to an application layer object. For example, a content server can transmit data packets carrying a frame of video in a burst, where the burst of packets arrives at the VIN sender over a short interval of time. Thus, bursts of packets transmitted from a content server corresponding to an application layer object arrive at the VIN sender in a burst. With the timer-based data block formation methods and embodiments described herein such a burst will be form a data block from which encoded data packets are generated and transmitted by the VIN sender to the receiver. Thus, with the timer-based data block formation methods and embodiments described herein, a VIN sender can generally form data blocks with the property that each data block carries all the data for a particular application layer object. Furthermore, with these methods and embodiments, a VIN sender does this without explicit knowledge of which packets carry data for which application layer objects.

### Other Information in Data Blocks

The method might further comprise including additional identifying data in a data block at the VIN sender that identifies which data from which of the packets of which of the first data packet streams is carried in each portion of the data block. The identifying information can be appended to the data block, which can include the size of each packet of the first data packet streams included in the data block and can include the number of packets of the first data packet streams that are included in the data block. In the example above, the identifying information 40, 40, 1280, 1280, 40, 1280, 1280, and 7 can be appended to the data block, where the number of bytes used to store each value is 4 bytes, in which case the total size of information carried in the data block is 5340+8*4=5372. If the encoded portion size is 1408 bytes (the size of the payload of an encoded data packet), then K=4 (5372/1408 rounded up to the nearest integer) for this data block. Then, the full data block size is 4*1408=5632 bytes. In a preferred embodiment, the identifying information is positioned at the end of the full data block, since this allows a VIN receiver to easily use the identifying information to extract the packets of the first data packet streams carried in the full data block once the full data block is recovered using erasure decoding at the VIN receiver. The VIN sender generates encoded packets from each full data block and transmits the encoded packets to a VIN receiver.

A VIN receiver can determine from the DBI, K, and EDI carried in the packet header of a received encoded packet the identity of the data block, the size of the data block in units of encoded packets, and how the encoded data portion carried in the packet payload was generated from the data block. The VIN receiver can determine when a data block is decodable based on comparing the number of encoded packets it has received for the data block to the K value carried in the packet headers of the encoded packets for the data block. When the number of received encoded packets for the data block is at least K, the VIN receiver can use an erasure decoder to reliably recover the data block from the received encoded packets. The VIN receiver can extract data packets of the first data packet streams from a recovered data block using the identifying data appended at the end of the data block (as described above) that identifies how many and the locations of packets of the first data packet streams carried in the data block. In the example above, the VIN receiver can read the last 4 bytes of the (full) data block, which carries the value 7, which is the number of packets of the first data packet stream carried in the data block. Then, the VIN receiver can read the previous seven 4-byte values, which are the sizes of the consecutive packets of the first packet streams carried in the data block. The VIN receiver can use this to extract the seven data packets of the first data packet streams from this data block and transmit them to their destinations.

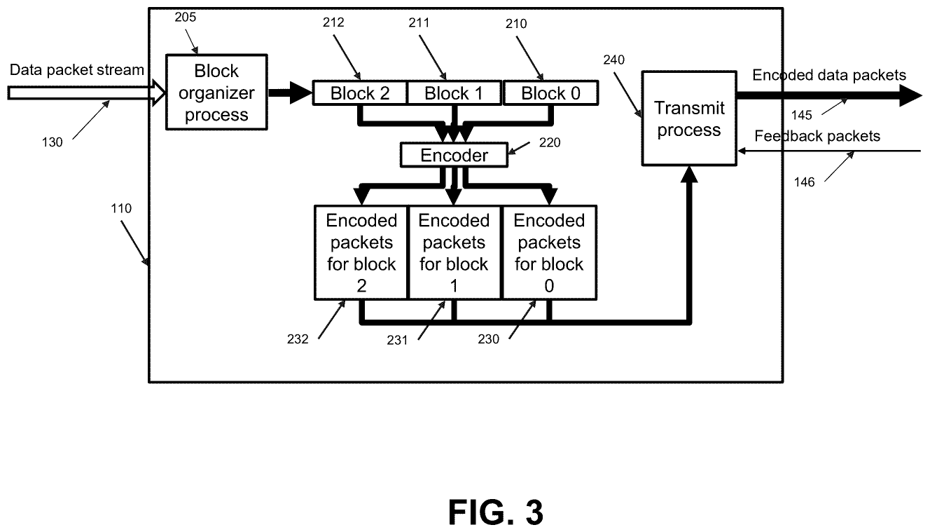

FIG. 3 illustrates a VIN sender generating and transmitting encoded data to a VIN receiver. As packets of a data stream (130) arrive at the VIN sender (110), the VIN sender organizes (205) the packets into data blocks (210, 211, 212). The VIN sender uses an erasure encoder (220) to generate encoded data packets for each of the data blocks (230, 231, 232). The VIN sender transmits (240) packets of the encoded data (145) to a VIN receiver. The VIN sender receives feedback packets (146) from the VIN receiver, wherein the feedback packets carry information that the VIN sender can use to adjust the amount of encoded data packets (145) to generate and transmit for each of the data blocks (210, 211, 212) of the data stream (130) to ensure reliable conversion of the encoded data packets into the data stream at the VIN receiver.

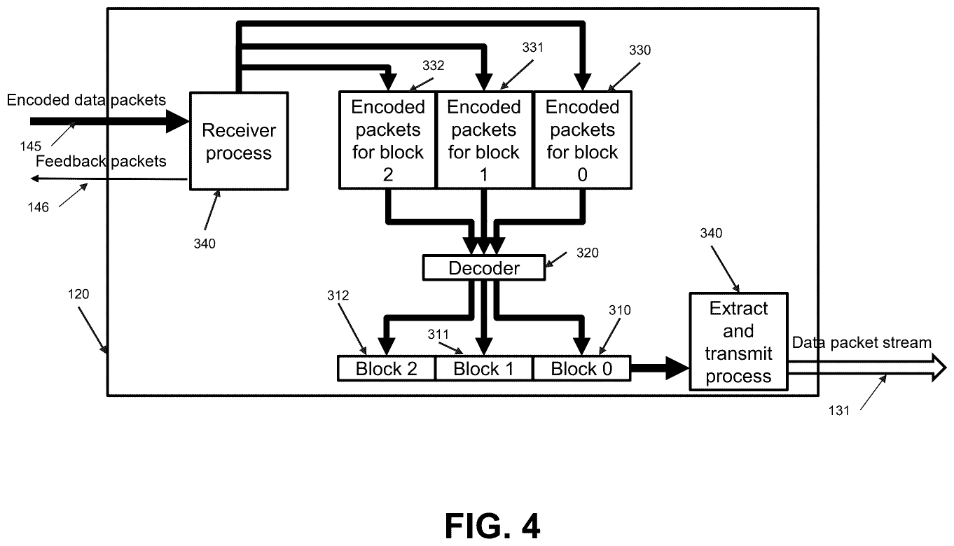

FIG. 4 illustrates a VIN receiver that receives encoded data packets from a VIN sender and recovers the original data packet stream using erasure decoding. As encoded data packets (145) are received (340) at the VIN receiver (120), the VIN receiver uses erasure decoding (320) to recover the original data blocks (310, 311, 312) from the received encoded data generated from those data blocks (330, 331, 332). The VIN receiver extracts and transmits (340) packets of the original data packet stream (131) to their destinations. The VIN receiver transmits feedback packets (146) as it is receiving encoded data packets (340) to the VIN sender, wherein the feedback packets carry information that the VIN sender can use to adjust the amount of encoded data packets (145) to generate and transmit for each of the data blocks (210, 211, 212) of the data stream (130) to ensure reliable conversion of the encoded data packets into the packets of the data stream at the VIN receiver.

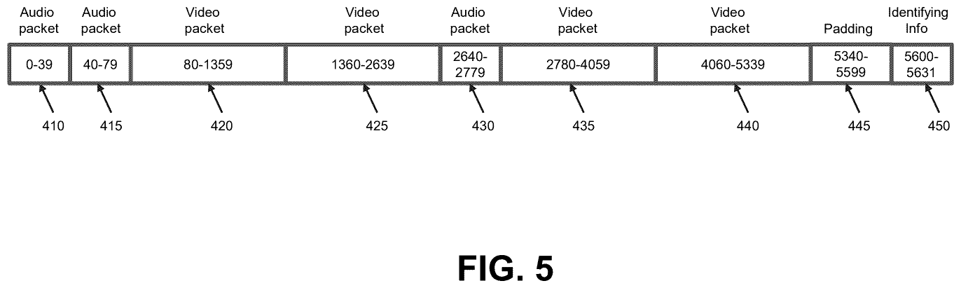

FIG. 5 illustrates a data block formed based on the example described above. In this illustration, the value in each box is the byte range of the corresponding data within the data block. The (full) data block comprises the concatenation of a 40-byte first audio packet (410), a 40-byte second audio packet (415), a 1280-byte first video packet (420), a 1280-byte second video packet (425), a 40-byte third audio packet (430), a 1280-byte third video packet (435), a 1280-byte fourth video packet (440), 260-bytes of padding (445), and 32-bytes of identifying information (450).

### Data for Block Transmitted Before all Data for the Block is Received at Sender

Many erasure codes, including the RaptorQ™ code specified in IETF RFC 6330, are systematic erasure codes, which means that the original data of the data block can be considered as encoded data. In more detail, the data of the (full) data block can be partitioned into equal sized source data portions, where the source data portion size is chosen to be the encoded data portion size. Each source data portion can be carried in the payload of an encoded data packet. The encoded data packet carrying the last source data portion of the data block does not need to include padding bytes preceding the identifying information, these padding bytes can be reinserted into the source data portion by the VIN receiver when the encoded data packet is received. The encoded data packets carrying source data portions are interchangeable with the other encoded data packets generated using the erasure encoder, in the sense that any K of the encoded data packets carrying either source data portions or encoded data portions is sufficient to recover the data block using an erasure decoder, where K is the size of the data block divided by the encoded data portion size.

It is beneficial to minimize the time from when a data packet of the first data packet streams arrives at a VIN sender to when the data packet is transmitted at a VIN receiver to its destination. To minimize this time, a VIN sender can form and transmit encoded data packets carrying source data portions of a data block before all the packets of the first data packet streams have arrived that will included in the data block. Since the value of K is generally not known until the data block is complete, at least some of the encoded data packets carrying source data portions can carry DBI, the value zero, and the EDI in the packet header, where the value zero indicates that the K-value for the data block is not yet determined. The packet headers of at least some of the encoded data packets carrying source data portions may carry the K-value in the packet header, for example for the encoded data packet carrying the last source data portion of the data block. The packet headers of all the encoded data packets carrying encoded data portions can carry the K-value in the packet header, as by the time they are generated the data block is complete and hence the value of K is determined.

A VIN receiver can reliably recover a data block from any K received encoded data packets for the data block. For example, if the VIN receiver receives all K encoded data packets carrying source data portions of the data block, then the VIN receiver receives the K-value for the data block in the packet header of the encoded data packet carrying the last source data portion. From this K-value and from the K received encoded data packets carrying source data portions, the VIN receiver can determine that it has reliably received all K source portions of the data block, and thus the VIN receiver can concatenate these K source portions to form the data block. If the VIN receiver does not receive all K encoded data packets carrying source data portions of the data block and yet the VIN receiver does receive at least K encoded data packets for the data block, then the VIN receiver received at least one encoded data packet carrying an encoded data portion, and the packet header of this encoded data packet carries the K-value. From this K-value and the K received encoded data packets carrying the EDI in the packet header, the VIN receiver can use an erasure decoder to reliably recover the data block. In either case, once the data block is recovered, the VIN receiver can use the identifying information at the end of the data block to extract the data packets of the first data packet streams carried in the data block. The VIN receiver can transmit the recovered data packets of the first data packet streams to their destinations.

### Encryption and Decryption of Data Blocks

Embodiments of a VIN may include encryption and decryption to provide the joint benefits of a VIN and a VPN. In one embodiment, a VIN sender can receive data packets of the first data packet streams, form data blocks from the received data packets, encrypt data blocks to produce encrypted data blocks, generate encoded data packets from encrypted data blocks using erasure encoding, and transmit encoded data packets to a VIN receiver. Correspondingly, a VIN receiver can receive encoded data packets, use erasure decoding to recover encrypted data blocks, use decryption to recover the original data blocks, recover data packets of the first data packet streams from the original data blocks, and transmit data packets of the first data packet streams to their destinations. Any suitable block encryption/decryption scheme can be used to encrypt data blocks into encrypted data blocks and to decrypt encrypted data blocks into original data blocks.

### Encryption of Packets

In another embodiment, a VIN sender can receive data packets of the first data packet streams, form data blocks from the received data packets, generate encoded data packets from data blocks using erasure encoding, encrypt encoded data packets to generate encrypted data packets, and transmit the encrypted data packets to a VIN receiver. Correspondingly, a VIN receiver can receive encrypted data packets, decrypt received encrypted data packets to generate encoded data packets, use erasure decoding to recover data blocks from the encoded data packets, recover packets of the first data packet streams from the recovered data blocks, and transmit packets of the first data packet streams to their destinations. Any suitable block encryption/decryption scheme can be used to encrypt data packets into encrypted data packets and to decrypt encrypted data packets into original data packets.

In another embodiment, a VIN sender can receive data packets of the first data packet streams, encrypt received the packets of the first data packet streams to form encrypted packets, form data blocks from encrypted packets, generated encoded data packets from data blocks using erasure encoding, and transmit the encoded data packets to a VIN receiver. Correspondingly, a VIN receiver can receive encoded data packets, use erasure decoding to recover data blocks from the received encoded data packets, recover encrypted data packets from the recovered data blocks, decrypt data packets of the first data streams from encrypted data packets, and transmit data packets of the first data packet streams to their destinations. Any suitable block encryption/decryption scheme can be used to encrypt data packets into encrypted data packets and to decrypt encrypted data packets into original data packets.

### Compression of Data Blocks

To reduce the amount of data that is transmitted, compression of data blocks might be employed. In one embodiment, a VIN sender can receive data packets of the first data packet streams, form data blocks from the received data packets, compress data blocks to produce compressed data blocks, generate encoded data packets from compressed data blocks using erasure encoding, and transmit encoded data packets to a VIN receiver. Correspondingly, a VIN receiver can receive encoded data packets, use erasure decoding to recover compressed data blocks, use decompression to recover the original data blocks, recover data packets of the first data packet streams from the original data blocks, and transmit data packets of the first data packet streams to their destinations. Any suitable block compression/decompression scheme can be used to compress data blocks into compressed data blocks and to decompress compressed data blocks into original data blocks. For example, a gzip compression/decompression algorithm can be used.

### Source and Destination Addresses and Ports

In some embodiments, there may be a multitude of first data packet streams from a multitude of sources. Thus, there may be a multitude of source IP addresses, destination IP addresses, and corresponding source and destination port numbers associated with the first data packet streams that arrive at a VIN sender. In some environments, for example when there are corporate firewall policies in place, it can be difficult to send a multitude of packet data streams with different destination port numbers and destination IP addresses to their destinations, since each destination port number and destination IP address that traverses the firewall might require a security administrator to allow the data packet stream through the firewall. In contrast, if a VIN is used to deliver the multitude of first data packet streams to their destinations through the firewall and the VIN sender and VIN receiver are on different sides of the firewall, then only a small, fixed number of ports and destination need be opened through the firewall to deliver all the first data packet streams to their destinations.

In more detail, the VIN sender receives packets of the multitude of first data packet streams, wherein a destination IP address and destination port is associated with each of these streams. The VIN sender converts the packets of the first data packet streams into a second packet stream comprising erasure coded data generated from the packets of the first packet streams. The VIN sender puts the same destination address and destination port number in all the packets of the second packet stream, where the destination address and destination port number are those of the VIN receiver. Thus, the VIN sender transmits packets of the second packet stream to the destination address and destination port of the VIN receiver. The VIN receiver receives packets of the second packet stream and reliably converts them, using erasure decoding, into packets of the first data packet streams. The VIN receiver transmits packets of the first data packet streams to the multitude of their destination addresses and destination ports. Thus, the corporate firewall only needs to be configured to let packets of the second data packet stream, with the destination IP address and destination port number associated with the VIN receiver, through the firewall, even though there can be a multitude of destination IP addresses and destination port numbers of packets of the first data packet streams that are transmitted to their destinations by the VIN receiver.

### Multiple Path Delivery

In some embodiments, it is preferable to use multiple network paths between a sender and receiver to reliably deliver data, since individual network paths may experience intermittent disruptions that make it difficult to reliably delivery data using an individual network path. Thus, in some embodiments, the method comprises one or more source devices that are configured to transmit one or more first data packet streams to one or more destinations, configuring the source devices to transmit the first data packet streams to a VIN sender. The VIN sender converts received packets of the first data packet streams into packets of a second data packet stream using erasure encoding and transmits packets of the second packet stream to a VIN receiver over multiple network paths between the VIN sender and the VIN receiver. The VIN receiver reliably converts using erasure decoding packets of the second packet stream received from the multiple network paths into packets of the first data packet streams. The VIN receiver transmits packets of the first data packet streams to their destinations.

In some embodiments, a VIN sender transmits packets of the second packet stream over more than one network interface to the VIN receiver. In other embodiments, a VIN receiver receives packets of the second packet stream over more than one network interface.

### Pairing VIN Endpoints to Establish a VIN Tunnel

In some embodiments, there are a plurality of VIN endpoints deployed at various locations, or at the same location. In some of these embodiments, the method comprises one or more source devices that are configured to transmit one or more first data packet streams to one or more destinations, configuring the source devices to transmit the first data packet streams to a first VIN endpoint. The first VIN endpoint converts packets of the first data packet streams into a second data packet stream comprising erasure coded data generated from the packets of the first data packet streams. The first VIN endpoint is paired with a second VIN endpoint from the plurality of VIN endpoints to establish a VIN tunnel. The first VIN endpoint transmits packets of the second data packet stream to the second VIN endpoint. The second VIN endpoint reliably converts received packets of the second packet stream into packets of the first data packet streams and transmits packets of the first data packet streams to their destinations.

In some embodiments, a first VIN endpoint and a second VIN endpoint can be paired from among the plurality of VIN endpoints based on the sources of the first data packet streams that are to be received by the first VIN endpoint. For example, if the source of the first data packet streams is a first Xbox cloud server, then a first VIN endpoint and a second VIN endpoint can be paired such that the first VIN endpoint is close to and has good connectivity with the first Xbox cloud server. If the source of the first data packet streams is a second Xbox cloud server, then a first VIN endpoint and a second VIN endpoint can be paired such that the first VIN endpoint is close to and has good connectivity with the second Xbox cloud server. If the source of the first data packet streams is a GeForce NOW server, then a first VIN endpoint and a second VIN endpoint can be paired such that the first VIN endpoint is close to and has good connectivity with the GeForce NOW server.

In some embodiments, a first VIN endpoint and a second VIN endpoint can be paired from among the plurality of VIN endpoints based the destinations of the first data packet streams that are being received by the first VIN endpoint. For example, if the destination of the first data packet streams is a first Xbox cloud server, then a first VIN endpoint and a second VIN endpoint can be paired such that the second VIN endpoint is close to and has good connectivity with the first Xbox cloud server. If the destination of the first data packet streams is a second Xbox cloud server, then a first VIN endpoint and a second VIN endpoint can be paired such that the second VIN endpoint is close to and has good connectivity with the second Xbox cloud server. If the destination of the first data packet streams is a GeForce NOW server, then a first VIN endpoint and a second VIN endpoint can be paired such that the second VIN endpoint is close to and has good connectivity with the GeForce NOW server.

In other embodiments, a first VIN endpoint and a second VIN endpoint can be paired from among the plurality of VIN endpoints based on the connectivity between the first VIN endpoint and the second VIN endpoint. For example, the first VIN endpoint may have better connectivity with some of the plurality of VIN endpoints than others, and thus the first VIN endpoint may be paired with a second VIN endpoint for which the connectivity between the first VIN endpoint and the second VIN endpoint is good compared to connectivity between the first VIN endpoint and some of the other plurality of VIN endpoints.

In other embodiments, a first VIN endpoint and a second VIN endpoint can be paired from among the plurality of VIN endpoints based on the connectivity between the second VIN endpoint and the destinations of the first data packet streams.

In other embodiments, a first VIN endpoint and a second VIN endpoint can be paired based on a combination of factors, e.g., based on the connectivity between the sources of the first data packet streams and the first VIN endpoint and based on the connectivity between the first VIN endpoint and the second VIN endpoint and based on the connectivity between the second VIN endpoint and the destinations of the first data packet streams.

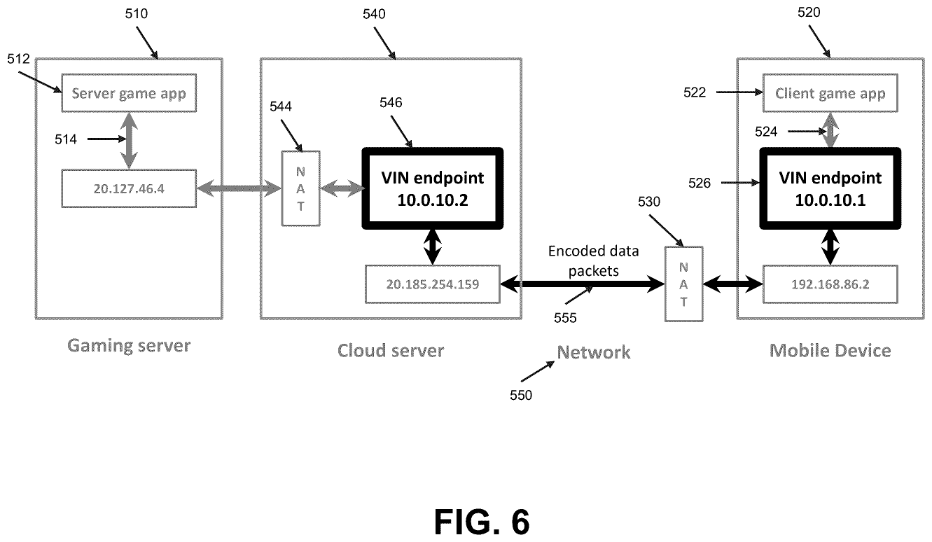

FIG. 6 illustrates a paired first VIN endpoint and second VIN endpoint that are used to enhance a cloud gaming service. The first VIN endpoint (526) is at the mobile device (520) at which an end user is playing a cloud game using a client game app (522). The second VIN endpoint (546) is at a cloud server (540) that has good connectivity to the gaming server (510). The client game app (522) is configured to transmit outgoing packet streams (524) to the first VIN endpoint (526). The first VIN endpoint generates an encoded data packet stream (555) that flows through the VIN tunnel over the network (550) to the second VIN endpoint (546). The second VIN endpoint reliably converts the encoded data packet stream into the original data packet stream and transmits this (514) to the server game app (512) at the gaming server (510). The server game app (522) is configured to send any outgoing packet streams (514) to the cloud server (540), where the NAT (544) is configured to forward these packet streams to the second VIN endpoint (546). The second VIN endpoint generates an encoded data packet stream (555) that flows through the VIN tunnel over the network (550) to the first VIN endpoint (526). The first VIN endpoint reliably converts the encoded data packet stream into the original data packet stream and transmits this (524) to the client game app (522) at the mobile device (520).

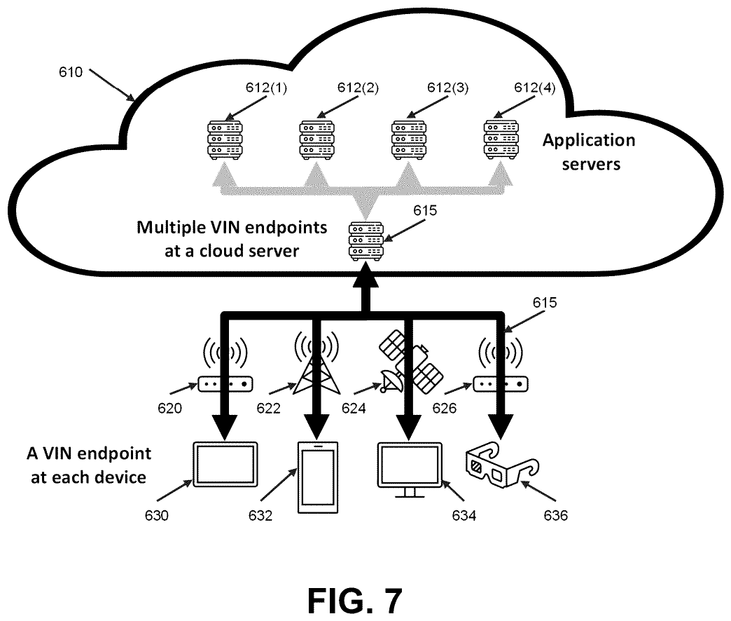

FIG. 7 illustrates a system of VIN endpoints integrated into a VIN service. A server cloud 610 might include a variety of different application servers (612(1), 612(2), 612(3), 612(4)) that may be providing different cloud services and may be in different data centers at different locations. Examples of commercial cloud services might include the Xcloud™ gaming service, NVIDIA's GeForce NOW™ service, the Netflix™ gaming service, A Zoom™ teleconference server, a Microsoft Teams™ teleconference server, a Twitch™ server, a Netflix™ server, a YouTube server, or similar. Private, OEM, or other cloud services might also be contemplated.

FIG. 7 shows a cloud server hosting multiple VIN endpoints (615), and in general there may be many cloud servers in different data centers at different locations, each cloud server hosting multiple VIN endpoints. FIG. 7 shows an example of multiple different types of devices that have VIN endpoints installed that are utilizing the cloud services. Those devices might include a tablet device (630), a mobile phone (632), a desktop computer (634), and AR/VR glasses (636). These devices might be connected to server cloud 610 through different types of access networks, e.g., through Wi-Fi (620, 626), through 5G (622), and through an LEO satellite network (624). The VIN endpoints on each of these devices are paired with a VIN endpoint at the server (615). Each of the devices may be connected to different cloud services supported at the application servers, and some devices may be concurrently connected to multiple cloud services. In the system shown in FIG. 7, data packet streams that are transmitted between the devices and the application servers flow through VIN tunnels between paired VIN endpoints.

### Sender Transmitting Different Streams to Different Receivers

In some embodiments, a VIN sender can be configured to send different streams of the first data streams to different VIN receivers. For example, a first portion of the first data packet streams might have a streaming game server as their destination and a second portion of the first data packet streams might have a sports broadcaster app as their destination. A VIN sender, upon receiving packets of the first data packet streams, partitions the packets into the first portion of first data packet streams and the second portion of first data packet streams. The VIN sender pairs a first VIN receiver with the first portion of the first data packet streams and pairs a second VIN receiver with the second portion of the first data packet streams. The VIN sender converts, using erasure encoding, received packets of the first portion into packets of a second data packet stream and transmits packets of the second data packet stream to the first VIN receiver. Similarly, the VIN sender converts, using erasure encoding, received packets of the second portion into packets of a third data packet stream and transmits packets of the third data packet stream to the second VIN receiver.

The first VIN receiver converts, using erasure decoding, received packets of the second data packet stream into packets of the first portion of the first data packet streams. The first VIN receiver transmits packets of the first portion to their destinations. Similarly, the second VIN receiver converts, using erasure decoding, received packets of the third data packet stream into packets of the second portion of the first data packet streams. The second VIN receiver transmits packets of the second portion to their destinations.

In another embodiment, a VIN sender partitions the one or more of the first data packet streams into a plurality of separate portions of the first data packet streams. The VIN sender pairs each of the separate portions with a separate VIN receiver. The VIN sender uses erasure encoding to generate a separate second data packet stream for the packets of each separate portion. The VIN sender transmits each of the separate second data packets streams to the separate VIN receiver paired with the separate portion. Each separate VIN receiver converts, using erasure decoding, packets of the separate second data packet stream received at that VIN receiver into packets of the separate portion paired with the VIN receiver. The VIN receiver transmits the packets of the separate portion of the first data packet streams to their destinations.

### Prioritizing Some Streams Over Others

In some use cases, different packet streams of the first data packet streams may have different delivery requirements. For example, some packet streams may carry primary value data that is extremely time sensitive, and thus it is crucial that these packet streams are delivered to their destinations with as little delay and as high reliability as possible. Other packet streams may carry secondary value data that is not time sensitive, and thus these packet streams can be delivered to their destination on a best effort basis.

In some embodiments, a VIN sender partitions packets one or more first data packet streams received from one or more source devices into a second data packet stream and a third data packet stream. The VIN sender converts packets of the second data packet stream into a first encoded data packet stream comprising erasure encoded data packets generated from the second data packet stream. The VIN sender converts packets of the third data packet stream into a second encoded data packet stream comprising erasure encoded data packets generated from the third data packet stream. The VIN sender transmits encoded data packets of the first encoded data packet stream and encoded data packets of the second encoded data packet stream to a paired VIN receiver, wherein encoded data packets of the first encoded data packet stream are transmitted with higher priority than encoded data packets of the second encoded data packet stream, wherein the number of encoded data packets of the first and second encoded data packet streams generated and transmitted by the VIN sender is based on feedback packets transmitted to the VIN sender from the VIN receiver and is based on the priorities of the second and third data packet streams. The VIN receiver reliably converts received encoded data packets of the first encoded data packet stream into the second data packet stream and reliably converts received encoded data packets of the second encoded data packet stream into the third data packet stream, wherein encoded data packets of the first encoded data packet stream are converted into packets of the second data packet stream with higher priority than encoded data packets of the second encoded data packet stream are converted into the third packet stream. The VIN receiver transmits packets of the second data packet stream and packets of the third data packet stream to the destinations.

The method might further comprise the VIN sender partitioning the one or more of the first data packet streams into multiple data packet streams of different priorities.

The method might further comprise priorities that are based on delivering data packet streams within a given latency budget. For example, the packets of the second data packet stream might carry real-time video data for an AR/VR application, which might have a delivery latency budget of 20 milliseconds, and the packets of the third data packet stream might carry background mapping data for the AR/VR application, which might have a much more relaxed delivery latency budget of 5 seconds. Thus, a VIN sender can transmit an encoded data packet of the first encoded data packet stream if there is an encoded data packet of the first encoded data packet stream ready to be transmitted when it is possible for the VIN sender to transmit the next packet to the network. The VIN sender can transmit an encoded data packet of the second encoded data packet stream if there is no encoded data packet of the first encoded data packet stream ready to be transmitted and there is an encoded data packet of the second encoded data packet stream that is ready to be transmitted when it is possible for the VIN sender to transmit the next packet to the network.

There are many variations of the embodiments. For example, a VIN sender can prioritize the second data packet stream over the third data packet stream by generating and transmitting a higher fraction of encoded data packets of the first encoded data packet stream relative to the number of data packets of the second data stream compared to the number of encoded data packets of the second encoded data packet stream that are generated and sent relative to the number of packets of the third data packet stream.

The method might further comprise priorities that are based on reliability of delivering the packets of a data packet stream.

### Sender or Receiver Influencing Source Arrival Rate

The allowed transmission rate at a VIN sender is the rate at which the VIN sender is allowed to transmit packets to its paired VIN receiver over the network. The allowed transmission rate at a VIN sender can fluctuate, as network conditions vary due to a variety of factors, where factors include changes in the amount of data traffic flowing through a shared network and changes in capacity and quality of a wireless portion of a network. The source arrival rate is the rate at which packets of the first data packet streams are arriving at the VIN sender. The needed transmission rate at the VIN sender to support a source arrival rate is the packet transmission rate needed by the VIN sender to reliably deliver all packets of the first data packet streams to the VIN receiver. If the needed transmission rate to support the current source arrival rate is higher than the allowed transmission rate at the VIN sender, then either not all packets of the first data packet streams can be reliably delivered to the VIN receiver or the reliably delivery time of packets of the first data packet streams to the VIN receiver will continually increase. Thus, it is desirable that the needed transmission rate at the VIN sender to support the current source arrival rate is at most the allowed transmission rate at the VIN sender. Thus, it is desirable for a VIN sender to be able to control the source arrival rate to ensure that the needed transmission rate at the VIN sender is at most the allowed transmission rate at the VIN sender.

In an embodiment of the methods and apparatus, a VIN sender determines, as packets of the first data packet streams arrive from sources, whether to receive or discard packets as they arrive. The source arrival rate of the remaining packets (those that are not discarded by the VIN sender) is hereafter referred to as the filtered source arrival rate. The VIN sender can discard some packets arriving from sources so that the needed transmission rate to support the filtered source arrival rate is at most the allowed transmission rate at the VIN sender. The VIN sender converts the received packets of the first data packet streams into encoded data packets using erasure encoding. The VIN sender transmits encoded data packets to a VIN receiver, where the rate at which the VIN sender transmits encoded data packets at any point in time is at or below the allowed transmission rate at the VIN sender at that point in time. The VIN receiver reliably converts received encoded data packets into packets of the first data packet streams and transmits packets of the first data packet streams to their destinations.

The method might further comprise determining, at the VIN sender, which packets to receive and which to discard from the first data packet streams based which packets are more important or crucial to deliver to the VIN receiver. The VIN sender can determine to discard data packets of a data packet stream among the plurality of first data packet streams, based for example on the priority of the data packet stream relative to the priority of the other data packet streams among the first data packet streams. For example, the first data packet streams may comprise a video packet stream and an audio packet stream, and the VIN sender may discard all data packets of the video packet stream and receive all data packets of the audio data packet stream when the allowed transmission rate at the VIN sender is below the needed transmission rate to reliably deliver both the audio data packet stream and the video data packet stream.

An embodiment includes methods and apparatus where a VIN sender delays reception of at least some data packets of the first data packet streams if the needed transmission rate for the VIN sender to support the source arrival rate is higher than the allowed transmission rate. For example, the first data packet streams may comprise a real-time video data packet stream for an AR/VR application, which might have a delivery latency budget of 20 milliseconds, and background mapping data stream, which might have a delivery latency budget of 5 seconds. The VIN sender may delay reception of data packets of the background mapping data stream and receive all data packets of real-time video data packet stream for the AR/VR application when the allowed transmission rate at the VIN sender is below the needed transmission rate to reliably deliver both the real-time video data packet stream and the background mapping data stream.

An embodiment includes methods and apparatus where a VIN sender reorders packets of the first data packet streams if the needed transmission rate for the VIN sender to support the source arrival rate is higher than the allowed transmission rate. For example, the first data packet streams may comprise a real-time video data packet stream for an AR/VR application. The VIN sender may reorder packets of the real-time video data packet stream before adding them to data blocks, generating and transmitting encoded data packets from data blocks, transmitting the encoded data packets to the VIN receiver, converting at the VIN receiver received encoded data packets to recover data blocks, extracting at the VIN receiver packets of the first data packet streams, and transmitting at the VIN receiver the packets of the first data packet streams to their destinations. Because the VIN sender reorders packet of the first data packet streams before adding them to data blocks, the VIN receiver will extract and transmit packets of the first data packet streams in the reordered order to their destinations. The reordering of packets by the VIN sender can be minimal, i.e., switching the order of two consecutive packets, and thus the reordering causes little to no increase in the delivery latency of packets of the first data packet streams to their destinations, and has no impact on the reliability of the delivery of the packets of the first data packet streams to their destinations.

As alternative embodiments of the methods and apparatus, if the VIN receiver determines the needed transmission rate at the VIN sender to support the source arrival rate is higher than the allowed transmission rate of the VIN sender then the VIN receiver can discard, delay, or reorder recovered packets of the first data packet streams before transmitting packets of the first data packet streams to their destinations.

Embodiments of the methods and apparatus might further include a VIN sender or VIN receiver that transmit signals to the sources or destinations of the first data packet streams when there is network congestion, i.e., when the allowed transmission rate at the VIN sender is below the needed transmission rate at the VIN sender to reliably deliver all packets of the first data packet streams to their destinations.

In the embodiments of the methods and apparatus described above, sources may decrease the source arrival rate to the VIN sender in response to the actions of the VIN sender or VIN receiver. For example, if the sources are using TCP, QUIC, WebRTC, or similar protocol to transmit packets of the first data streams to the VIN sender, then the response of sources to packet discards, packet reordering, or packet delays induced by the VIN sender or VIN receiver as described above is to decrease the rate at which the sources transmit packets of the first data packet streams to the VIN sender.

### Sender Control of Allowed Transmission Rate

It is desirable that a VIN sender transmits packets at a rate at which the network can handle the packets without filling packet queues in routers, switches, access points. If packet queues fill then the time it takes to deliver a packet from the VIN sender to the VIN receiver becomes too large due to packets delayed behind other packets in packet queues, or else packets are lost due to overflow in packet queues.

Embodiments of methods and apparatus are described wherein the VIN sender determines an allowed transmission rate at which packets can be transmitted without filling packet queues in the path between the VIN sender and a VIN receiver. The VIN sender can base the allowed transmission rate on feedback packets received from the VIN receiver. In one embodiment, feedback packets received from the VIN receiver include packet loss information about packets transmitted from the VIN sender to the VIN receiver. If the packet loss reported in feedback packets received by the VIN sender is high then the VIN sender can reduce the allowed transmission rate, whereas if the packet loss reported in feedback packets received by the VIN sender is low then the VIN sender can increase the allowed transmission rate.

In another embodiment of methods, a VIN receiver can transmit feedback packets to a VIN sender that include the timing of received packets from the VIN sender, and the VIN sender can base the allowed transmission rate based on this timing information. For example, if the delivery latency of packets from the VIN sender to the VIN receiver is increasing then this is an indication that packet queues in the network along the path between the VIN sender and VIN receiver are increasing, which is an indication that the current transmission rate of the VIN sender needs to decrease. Thus, if the timing indicates that the delivery latency of packets from the VIN sender to the VIN receiver is increasing then the VIN sender can decrease the allowed transmission rate, whereas if the timing indicates that the delivery latency of packets is remaining the same or decreasing then the VIN sender can increase the allowed transmission rate.

In another embodiment of methods and apparatus, a VIN sender can receive information from the network interface over which the VIN sender is transmitting packets, and the VIN sender can adjust the allowed transmission rate based on the network interface information. For example, network interface information can include the current outgoing available bandwidth on that network interface, and the VIN sender can set the allowed transmission rate to the current outgoing available bandwidth of that network interface. As another example, network interface information can include signal to noise levels and congestion levels, and the VIN sender can set the allowed transmission rate based on signal to noise levels and congestion levels.

In another embodiment of methods and apparatus, a VIN sender can set the allowed transmission rate based on a transmission rate parameter setting, e.g., a transmission rate parameter might be set to 100 Mbps, in which case the VIN sender can set the allowed transmission rate to 100 Mbps.

In another embodiment of methods and apparatus, a VIN sender can base the allowable transmission rate, at least in part, on the current arrival rate of packets of the first data packet streams at the VIN sender. For example, the VIN sender can set the allowable transmission rate to twice the current arrival rate of packets of the first data packet streams at the VIN sender.

### Sender Control of Allowed Transmission Rate Over Multiple Network Paths

As described above, there are benefits to transmitting packets over multiple network paths between a VIN sender and a VIN receiver. In embodiments of these methods, a VIN sender can determine an allowed transmission rate for each such network path. Embodiments of these methods and apparatus might further comprise a VIN sender that bases the allowed transmission rate over each network path on feedback packets received from the VIN receiver carrying information about delivery of packets over that network path. In embodiments of these methods and apparatus, the VIN sender can set the allowed transmission rate to the sum over each network path over which the VIN sender transmits packets to the VIN receiver of the allowed transmission rate for that network path.

### Explicit Congestion Notification

As described above, one of the barriers to supporting interactive applications that require ultra-low latency data delivery across networks is filling packet queues in routers, switches, access points. If packet queues fill then the time it takes to deliver a packet from the VIN sender to the VIN receiver becomes too large due to packets delayed behind other packets in packet queues, or else packets are lost due to overflow packet queues. Thus, it is desirable to transmit packets across the network to avoid packets becoming delayed or lost from packet queues. On the other hand, it is desirable that all packets arriving from sources to the VIN sender are reliably delivered to the VIN receiver. Thus, what is desired are methods and apparatus that control the rate at which sources transmit packets of the first data packet streams to the VIN sender so that all packets of the first data packet streams can be reliably delivered with low latency to the VIN receiver.

### Explicit Congestion Notification

Work in the IETF is focused on this issue, as described in IETF RFC 9330. The primary focus of this work is to minimize packet delivery latency and packet loss for latency sensitive data packet streams.

The architecture described in IETF RFC 9330 generally has three parts: (1) the explicit congestion notification (ECN) field, (2) network support, and (3) support for source-destination pairs of latency sensitive data packet streams. The explicit congestion notification (ECN) field in IP packet headers is set to identify packets belonging to latency sensitive data packet streams. The network support isolates latency sensitive data packet streams from other Internet traffic. The essential idea there is to route packets with the ECN field set (indicating they are packets of latency sensitive data packet streams) through latency sensitive packet queues in network elements. The latency sensitive packet queues are designed to minimize the amount of time packets spend in the queues; as queues fill, the ECN field of packets in the queue are modified to indicate congestion experienced (CE). ECN-capable network elements are network elements that deploy suitable queueing policies compatible with RFC 9330. Support for source-destination pairs of latency sensitive data packet streams might employ suitable rate control protocols to control the allowable packet transmission rate for latency sensitive data packet streams. In essence, when source-destination pair of a latency sensitive data packet stream receives packets with the ECN modified to indicate CE, the source-destination pair reduces the rate of generation and transmission of packets of the latency sensitive data packet stream. An ECN-capable source-destination pair, as used herein, is a source-destination pair that employs suitable rate control protocols compatible with RFC 9330.

### Sender Uses ECN in Encoded Packet Stream

Embodiments of methods and apparatus for VIN senders and receiver to leverage the work described in IETF RFC 9330 is hereafter described. In one embodiment of the methods and apparatus, one or more source devices are configured to transmit one or more first data packet streams to one or more destinations. The source devices are configured to transmit packets of the first data packet streams to a VIN sender. The VIN sender uses an erasure encoder to generate an encoded data packet stream comprising erasure coded data generated from received packets of the first data packet streams. The VIN sender sets the explicit congestion notification (ECN) field in the IP packet headers of the packets of the encoded data packet stream to indicate ECN-Capable Transport (ECT). The VIN sender transmits packets of the encoded data packet stream to a VIN receiver. The VIN receiver reliably converts, using an erasure decoder, received encoded packets of the encoded data packet stream into packets of the first data packet streams. The VIN receiver transmits packets of the first data packet streams to their destinations. The number of encoded packets of the encoded data packet stream generated and transmitted by the VIN sender to ensure reliable conversion is based on feedback packets transmitted from the VIN receiver to the VIN sender.

### Adjustment of Allowed Transmission Rate Based on CE

The method might further comprise detecting, at the VIN receiver, if encoded packets of the encoded data packet stream received at the VIN receiver had their ECN field modified to indicate congestion experienced (CE) by ECN-capable network elements, indicating network congestion between the VIN sender and the VIN receiver. The VIN receiver can generate and transmit feedback packets to the VIN sender indicating that encoded packets of the encoded data packet stream have been received by the VIN receiver with their ECN field modified to indicate CE.

The method might further comprise, at the VIN sender, adjusting the allowed transmission rate of encoded packets of the encoded data packet stream based on feedback from the VIN receiver carrying information about which packets of the encoded data packet stream received at the VIN receiver have had their ECN field modified to indicate congestion experienced (CE) by ECN-capable network elements indicating network congestion between the VIN sender and the VIN receiver. The VIN sender can decrease the allowed transmission rate if there is a high frequency of packets received at the VIN receiver with their ECN field modified to indicate CE, and the VIN sender can increase the allowed transmission rate if there is a low frequency of packets received by the VIN receiver with their ECN field modified to indicate CE.

Explicit Congestion Notification-Transferred from Encoded to Source-ECN-Capable Network

A desirable goal is to convey information to ECN-capable source-destination pairs of first data packet streams that allows them to adjust the source arrival rate of the first data packet streams to a VIN sender. Embodiments of methods and apparatus that achieve this goal are herein described.

One or more ECN-capable source-destination pairs are configured to transmit one or more first data packet streams to a VIN sender, wherein the explicit congestion notification (ECN) field in the IP packet headers of packets of the first data packet streams are set to indicate ECN-Capable Transport (ECT). The VIN sender generates, using an erasure encoder, encoded packets of an encoded data packet stream comprising erasure coded data generated from packets of the first data packet streams. The VIN sender sets the explicit congestion notification (ECN) field in the IP packet headers of the encoded packets of the encoded data packet stream to indicate ECN-Capable Transport (ECT). The VIN sender transmits encoded packets of the encoded data packet stream to a VIN receiver. The VIN receiver reliably recovers, using erasure decoding, packets of the first data packet streams from received encoded packets of the encoded data packet stream. The VIN receiver detects if the ECN field of received encoded packets of the encoded data packet stream have been modified by ECN-capable network elements to indicate congestion experienced (CE) by network elements between the VIN sender and the VIN receiver indicating network congestion. The VIN receiver modifies the explicit congestion notification field to indicate CE in those packets of the first data packet streams that are recovered using encoded packets indicating CE of the encoded data packet stream. The VIN receiver transmits packets of the first data packet streams to their destinations.

The method might further comprise, at the VIN sender, setting the explicit congestion notification (ECN) field in the IP packet headers of the encoded packets of the encoded data packet stream to indicate ECN-Capable Transport (ECT) only if the explicit congestion notification (ECN) field in the IP packet headers of the packets of the first data packet streams is set to indicate ECN-Capable Transport (ECT).

### Explicit Congestion Notification-VIN Taking on Role of Network-No ECN-Capable Network Elements

While some networks support the architecture described in IETF RFC 9330, many networks do not support the architecture. Moreover, it may never be the case that all networks support the architecture described in IETF RFC 9330. On the other hand, a beneficial goal is to universally deploy of ECN-capable source-destination pairs to support latency sensitive applications. The embodiments of the methods and apparatus described below enable ECN-capable source-destination pairs to be deployed on networks without ECN-capable network elements.

An embodiment of the methods and apparatus can comprise one or more sources that are configured to transmit one or more first data packet streams to one or more destinations, wherein the explicit congestion notification (ECN) field in the IP packet headers of the packets of the first data packet streams are set to indicate ECN-Capable Transport (ECT). The sources are configured to transmit the first data packet streams to a VIN sender. The VIN sender determines the current allowed transmission rate at the VIN sender using the methods and apparatus described herein. The VIN sender calculates the current source arrival rate based on the rate at which packets of the first packet streams are currently arriving to the VIN sender from sources. The VIN sender detects if the needed transmission rate at the VIN sender to support the current source arrival rate is larger than the current allowed transmission rate at the VIN sender. If the needed transmission rate at the VIN sender to support the current source arrival rate is detected to be larger than the current allowed transmission rate at the VIN sender, then the VIN sender modifies the explicit congestion notification field to indicate congestion experienced (CE) in packets of the first data packet streams. The VIN sender uses an erasure encoder to generate encoded packets of an encoded data packet stream comprising erasure coded data generated from the packets of the first data packet streams. The VIN sender transmits encoded packets of the encoded data packet stream to a VIN receiver. The VIN receiver receives encoded packets of the encoded data packet stream and reliably generates, using erasure decoding, packets of the first data packet streams from encoded packets of the encoded data packet stream. The VIN receiver transmits packets of the first data packet streams to their destinations. In this embodiment, the explicit congestion notification (ECN) field in the IP packet headers are set to indicate ECN-Capable Transport (ECT), and the congestion experienced (CE) in the IP headers are modified as indicated above by the VIN sender, in the packets of the first data packet streams that the VIN receiver transmits to their destinations. Thus, the VIN tunnel acts as a network element in this embodiment that can be used to signal to ECN-capable source-destination pairs when there is congestion in the network, even when there are no network elements (routers, switches) that are ECN-capable along the path between a VIN sender and a VIN receiver.

There are many combinations of the embodiments of the methods and apparatus described above. For example, embodiment of the methods and apparatus can comprise one or more sources that are configured to transmit one or more first data packet streams to one or more destinations, wherein the explicit congestion notification (ECN) field in the IP packet headers of the packets of the first data packet streams are set to indicate ECN-Capable Transport (ECT). The sources are configured to transmit the first data packet streams to a VIN sender. The VIN sender uses an erasure encoder to generate encoded packets of an encoded data packet stream comprising erasure coded data generated from the packets of the first data packet streams. The VIN sender transmits encoded packets of the encoded data packet stream to a VIN receiver. The VIN receiver receives encoded packets of the encoded data packet stream and reliably generates, using erasure decoding, packets of the first data packet streams from encoded packets of the encoded data packet stream. The VIN receiver determines the current allowed transmission rate at the VIN sender using the methods and apparatus described previously. The VIN receiver calculates the current source arrival rate based on the rate at which packets of the first packet streams are currently arriving to the VIN sender from sources. The VIN receiver detects if the needed transmission rate at the VIN sender to support the current source arrival rate is larger than the current allowed transmission rate at the VIN sender. If the needed transmission rate at the VIN sender to support the current source arrival rate is detected to be larger than the current allowed transmission rate at the VIN sender, then the VIN receiver modifies the explicit congestion notification field to indicate congestion experienced (CE) in packets of the first data packet streams. The VIN receiver transmits packets of the first data packet streams to their destinations.

### Setting Congestion Experienced (CE) Indicators in a VIN Tunnel

An embodiment of a method for the VIN sender or VIN receiver to set the CE in packets of the first data packet streams is the following. There are two parameters that are either preset to specific values or set according to measurements across the network by the VIN sender and VIN receivers: a target latency value, hereafter referred to as TarLat, and a maximum latency value, hereafter referred to as MaxLat. For example, TarLat might be set to 20 ms, and MaxLat might be set to 150 ms. The target latency value is an upper bound target on reasonable latency for data packets sent through the VIN tunnel, and the maximum latency value is an upper bound on the allowed latency for data packets sent through the VIN tunnel.

The VIN sender and VIN receiver continually measure the packet latency through the VIN tunnel. The measured round-trip time (RTT) can be used, where the round-trip time is the amount of time it takes for a packet transmitted from the VIN sender to arrive at the VIN receiver plus the time it takes for a response packet transmitted from the VIN receiver to arrive at the VIN sender. The RTT can also be measured as the time between transmitting a packet from the VIN receiver until receiving a response packet at the VIN receiver from the VIN sender. Alternatively, the one-way time (OW) from the VIN sender to the VIN receiver can be measured, i.e., the amount of time it takes for a packet transmitted from the VIN sender to arrive at the VIN receiver. Herein, the examples refer to a method based on the RTT, but the OWT can instead be used in a variant of the method based on the RTT. The RTT can be continually measured through the VIN tunnel by sending a sequence of ping packets and measuring the time between transmitting each ping packet and receiving the response, for example. As another example, the RTT can be measured based on the transit time of encoded packets from the VIN sender to the VIN receiver together with the transit time of feedback from the VIN receiver to the VIN sender about reception of such encoded packets at the VIN receiver.

The RTT can be measured on a continual basis, and estimate of the RTT can be maintained, hereafter referred to as eRTT, wherein eRTT is an average of measured RTTs over a relatively short period of time, so that more recent RTT measurements are weighted much more heavily in eRTT than RTT measurements from the past. For example, eRTT can be updated as eRTT=alpha*R+(1−alpha)*R, where alpha is a fixed constant, for example alpha=0.10, whenever there is a new measurement R of the RTT.

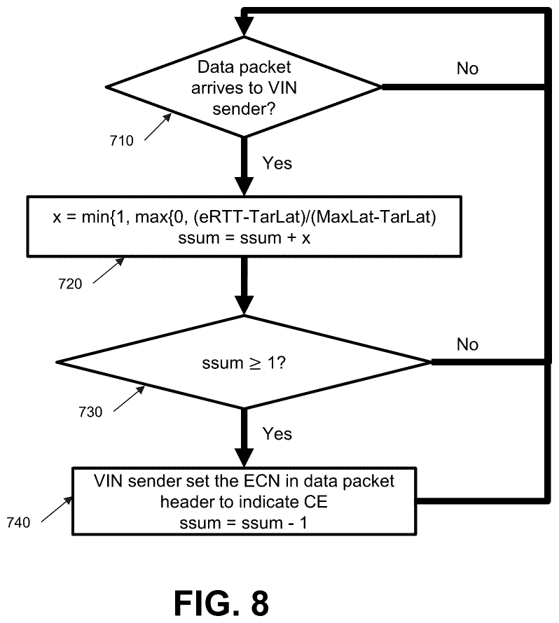

The VIN sender can decide how to set the CE in data packets of the first data packet streams as follows, referring to FIG. 8. The value of a variable ssum is initialized to zero before any data packets of the first data packet streams arrive at the VIN sender. Each time a data packet of the first data packet streams arrives at the VIN sender (710), the VIN sender uses the current value of eRTT to decide whether to indicate CE in the data packet as follows. The VIN sender determines the value of a variable x as: x=min {1, max {0, (eRTT-TarLat)/(MaxLat-TarLat)}} (720). Then, the VIN sender updates the value of ssum as: ssum=ssum+x (720). The VIN sender checks to see if ssum≥1 (730). If this is true then the VIN sender sets the ECN in the data packet header to indicate congestion experienced (CE) (740) and updates ssum as: ssum=ssum−1 (740), whereas if this is false then the VIN sender does not set the ECN to indicate congestion experienced in the packet and does not update the value of ssum. The value of ssum is always between 0 and 1 at the end of this process for a data packet, and the ECN in the data packet header is set to indicate congestion experienced if the value of ssum is at least 1 after the value of x is added to ssum during the processing of the data packet.

The proportion of data packets for which the VIN sender sets the ECN in data packet headers to indicate congestion experienced (CE) is proportional x, where x is as specified above, when eRTT stays at roughly the same value over multiple data packets. For example, if eRTT=100 ms for multiple consecutive data packets, and TarLat=75 ms and MaxLat=275 ms, then the VIN sender sets the ECN in data packet headers to indicate congestion experienced (CE) in a proportion of 25/200=0.125 of the multiple consecutive data packets on average, i.e., the VIN sender sets the ECN in the data packet header to indicate congestion experienced (CE) in approximately 12.5% of the multiple consecutive data packets.

The above method can be modified so that the processing logic is at the VIN receiver rather than at the VIN sender, wherein the VIN receiver either sets or does not set the CE in data packets of the first data packet streams before transmitting the data packets to their destinations.

A further variant is to include packet loss estimates of encoded packets transmitted through the VIN tunnel in the determination of whether to set the CE in data packets of the first data packet streams before they are transmitted to their destinations. The packet loss estimates can be determined either at the VIN sender or at the VIN receiver. When the packet loss estimates are higher the VIN sender or VIN receiver is more likely to set the CE in data packets of the first data packet streams, whereas if the packet estimates are lower the VIN sender or VIN receiver is less likely to set the CE in data packets of the first data packet streams.

The VIN sender can decide how to set the CE in data packets of the first data packet streams as follows based on a packet loss estimate (“ploss”) that is continually updated based on encoded packet loss through the VIN tunnel, where ploss is a value that is between 0 and 1. The value of a variable ssum is initialized to zero before any data packets of the first data packet streams arrive at the VIN sender. Each time a data packet of the first data packet streams arrives at the VIN sender, the VIN sender uses the current value of ploss to decide whether to indicate CE in the data packet as follows. The VIN sender updates the value of ssum as: ssum=ssum+ploss. The VIN sender checks to see if ssum≥1. If this is true, then the VIN sender sets the ECN in the data packet header to indicate congestion experienced (CE) and updates ssum as: ssum=ssum−1, whereas if this is false then the VIN sender does to indicate congestion experienced in the packet and does not update the value of ssum. The value of ssum is always between 0 and 1 at the end of this process for a data packet, and the ECN in the data packet header is set to indicate congestion experienced if the value of ssum is at least 1 after the value of ploss is added to ssum during the processing of the data packet.

There are many variants of the above methods. For example, the value of ssum can be updated as ssum=ssum+beta*ploss, where beta is a positive constant. As another variant, ssum can be updated as ssum=ssum+x+ploss, where x is determined as described above based on eRTT. As an example of another variant, ssum can be updated as ssum=ssum+max {0, ploss-beta}, where beta is a positive constant. In this variant, ssum only increases if ploss is at least beta, which means that packet loss rates below a rate of beta do not influence the congestion experienced (CE) indicators to be set in packet headers of data packets.

In some embodiments, the VIN sender sets the ECN to indicate CE in data packets. In some embodiments, the VIN receiver sets the ECN to indicate CE in data packets, since then ECN-capable source-destination pairs receive the CE indicator in a data packet of the first data packet streams when the VIN receiver transmits the data packet to its destination. It might also be possible for some apps to indicate CE in the feedback packets from the ECN-capable destination to the ECN-capable source at the VIN sender, as this provides pretty much instant feedback CE to the ECN-capable source. The ECN-capable source typically controls the source sending rate of data packets of the first data packet streams.

### Explicit Congestion Notification—VIN Taking on Role of Network+ECN-Capable Network

There are many combinations of the embodiments of the methods and apparatus described above. For example, the above methods and embodiments described above where the VIN tunnel explicitly indicates congestion experienced without any network elements that are ECN-capable can be augmented to leverage ECN-capable network elements in the network. In addition to the methods and embodiments described above where the VIN tunnel explicitly indicates congestion experienced without any network elements that are ECN-capable, the VIN sender can also set the IP packet headers of the encoded packets of the encoded data packet stream to indicate ECN-Capable Transport (ECT), which is beneficial when there are ECN-capable elements along the network path between a VIN sender and VIN receiver. The VIN receiver can detect if the ECN field of received encoded packets of the encoded data packet stream have been modified by ECN-capable network elements to indicate congestion experienced (CE) by network elements between the VIN sender and the VIN receiver indicating network congestion. The VIN receiver can use a combination of CE indications set by network elements in encoded packets received from the VIN sender and CE indications set by the VIN sender in data packets of the first data packet streams to decide how to set the CE indications in the data packets of the first data packet streams that the VIN receiver transmits to their destinations. For example, the VIN receiver may set the CE field to indicate congestion experienced in data packets of the first data packet streams that the VIN transmits to their destinations if either network elements sets the CE field to indicate congestion experienced in encoded packets (when network elements determine there is congestion in the path along which the encoded packets flow) or if the VIN sender sets the CE field to indicate congestion experienced in data packets of the first data packet streams (when the VIN sender determines there is congestion in the path between the VIN sender and VIN receiver).

In another embodiment, the VIN receiver may employ methods and embodiments as described above to determine when there is congestion between the VIN sender and receiver, and the VIN receiver may set the CE field to indicate congestion experienced in data packets of the first data packet streams based on a combination of CE indications in encoded packets received by the VIN receiver (when network elements determine there is congestion in the path along which the encoded packets flow) and on when the VIN receiver determines that there is congestion between the VIN sender and VIN receiver.

Classifying Data Packets Arriving to the VIN Sender into Different Categories

Data packets of the first data packet streams arriving to a VIN sender may be classified into two categories: a first category of data packets without the ECN capable bit turned on, and a second category of data packets with the ECN capable bit turned off. The first category of data packets corresponds to data packets transmitted by data delivery applications that do not have tight latency constraints, whereas the second category of data packets corresponds to data packets transmitted by data delivery applications that do have tight latency constraints.

Data packets of the first category can be collected in a first queue, where packets are allowed to collect in the first queue to a fairly large depth, where depth can be measured in terms the maximum amount of time packets in the first queue are allowed to stay in a FIFO (first-in first-out) first queue before being transmitted, or in terms of how many packets are allowed to be stored in the first queue. For example, there could be a time upper bound of 10 seconds on the first queue, or a 10,000-packet limit on how may packets are allowed to collect in the first queue, or a 10 MB limit on the total size packets are allowed to collect in the first queue. Once the first queue is full, it overflows, in the sense that all arriving data packets of the first category are discarded as they arrive at the VIN sender until the first queue has capacity for more packets.

Data packets of the second category can be collected in a second queue, where packets are only allowed to collect in the second queue to a shallow depth, where depth can be measured in terms the maximum amount of time packets in the second queue are allowed to stay in a FIFO (first-in first-out) first queue before being transmitted, or in terms of how many packets are allowed to be stored in the first queue. For example, there could be a time upper bound of 200 ms on the second queue, or a 200-packet limit on how may packets are allowed to collect in the second queue, or a 2.5 MB limit on the total size packets are allowed to collect in the second queue. Once the second queue is full, it overflows, in the sense that all arriving data packets of the first category are discarded as they arrive at the VIN sender until the second queue has capacity for more packets.

A VIN server or VIN app can run two VIN senders, a first VIN sender that handles data packets of the first category and a second VIN sender that handles data packets of the second category. Since the data packets of the second category are transmitted by ECN-capable source-destination pairs, the second VIN sender can use the methods and embodiments described above to set the CE field to indicate congestion experienced for data packets of the second category that arrive to the second VIN sender. The first VIN sender can allow data packets of the first category to collect into a second larger queue, since these data packets are for applications that are not time sensitive.

The allowed rate of data packets of the first data packet streams arriving to a VIN server or VIN app can be divided between the two categories. For example, the allowed arrival rate of data packets of the first category can be the same as the allowed arrival rate of data packets of the second category. As another example, the allowed arrival rate of data packets of the second category can be greater than the allowed arrival rate of data packets of the second category. The allowed arrival rate of data packets between the two categories can flexibly be allocated based on the actual arrival rate of data packets for each category. For example, the overall arrival rate of data packets for both categories is higher than the VIN tunnel can handle then the data packets of the second category can be given higher priority (not discarded at the second VIN sender) and the data packets of the first category can be given lower priority (discarded if necessary at the second VIN sender).

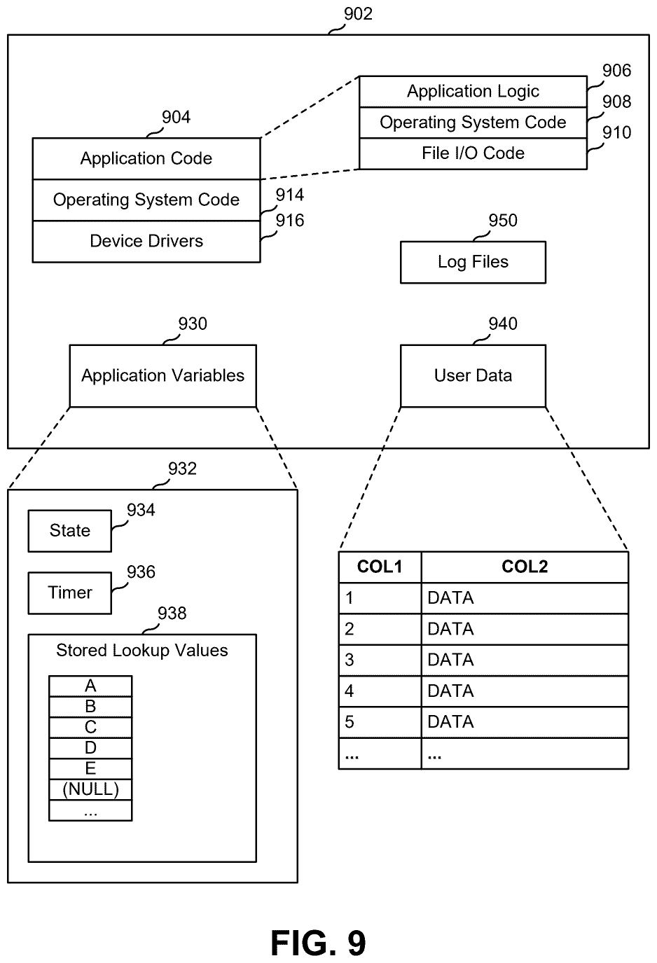

FIG. 9 is a simplified functional block diagram of a storage device 902 having an application that can be accessed and executed by a processor in a computer system as might be part of embodiments of a tunnel-based transmission system and/or a computer system that performs reliable data transport as described herein. FIG. 9 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 902 can be one or more memory device that can be accessed by a processor and storage device 902 can have stored thereon application code 904 that can be one or more processor readable instructions, in the form of write-only memory and/or writable memory. Application code 904 can include application logic 906, library functions 908, and file I/O functions code 910 associated with the application. The memory elements of FIG. 9 might be used for a server or computer that interfaces with a user, generates data, and/or manages other aspects of a process described herein. In addition to application code 904, storage device 902 might also contain operating system code 914 and device drivers 916.

Storage device 902 can also include storage for application variables 930 that can include one or more storage locations configured to receive variables 932. Application variables 930 can include variables that are generated by the application or otherwise local to the application, such as state variables 934, timers 936, and/or stored lookup values 938. Application variables 930 can be generated, for example, from data retrieved from an external source, such as a user or an external device or application. A processor can execute application code 904 to generate application variables 930 provided to storage device 902. Application variables 930 might include operational details needed to perform the functions described herein.

Storage device 902 can include storage for databases and other data described herein. One or more memory locations can be configured to store user data 940, which might include data sourced by an external source, such as a user or an external device. User data 940 can include, for example, records being passed between servers prior to being transmitted or after being received. Other data might also be supplied.

Storage device 902 can also include log files 950 having one or more storage locations configured to store results of the application or inputs provided to the application. For example, log files 950 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

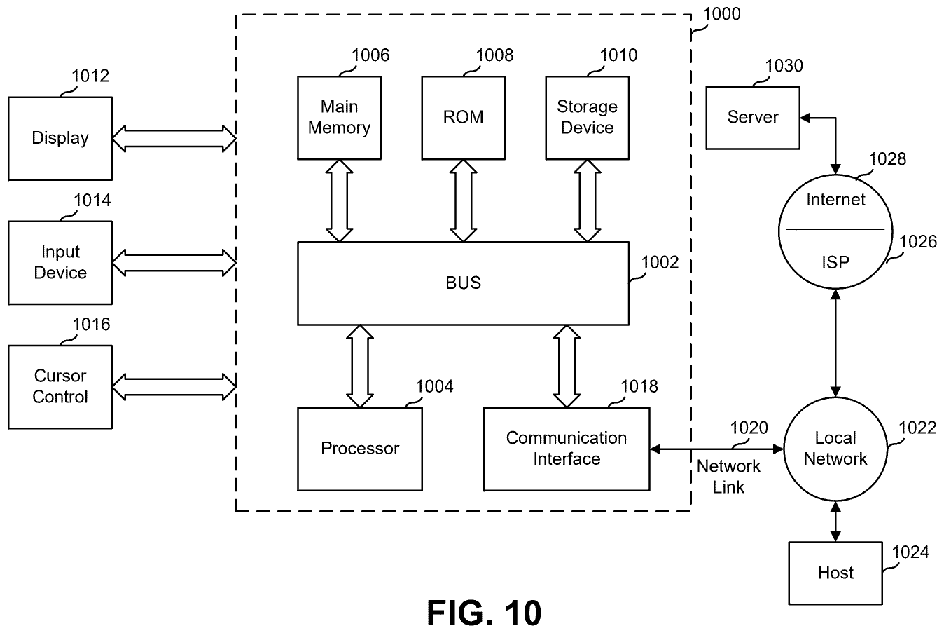

FIG. 10 is a block diagram that illustrates a computer system 1000 upon which the computer systems of the systems described herein and/or data structures shown in FIG. 9 may be implemented. Computer system 1000 includes a bus 1002 or other communication mechanism for communicating information, and a processor 1004 coupled with bus 1002 for processing information. Processor 1004 may be, for example, a general-purpose microprocessor.

Computer system 1000 also includes a main memory 1006, such as a random-access memory (RAM) or other dynamic storage device, coupled to bus 1002 for storing information and instructions to be executed by processor 1004. Main memory 1006 may also be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a computer monitor, for displaying information to a computer user. An input device 1014, including alphanumeric and other keys, is coupled to bus 1002 for communicating information and command selections to processor 1004. Another type of user input device is a cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a network connection. A modem or network interface local to computer system 1000 can receive the data. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be a network card, a modem, a cable modem, or a satellite modem to provide a data communication connection to a corresponding type of telephone line or communications line. Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world-wide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020, and communication interface 1018. In the Internet example, a server 1030 might transmit a requested code for an application program through the Internet 1028, ISP 1026, local network 1022, and communication interface 1018. The received code may be executed by processor 1004 as it is received, and/or stored in storage device 1010, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of transmitting one or more first data packet streams from one or more sources to one or more destinations with reliability of transmission, the method comprising:
configuring, at the one or more sources, transmission of packets of the first data packet streams to a sender;
receiving, at the sender, packets of the first data packet streams from the one or more sources;
converting, at the sender, packets of the first data packet streams into packets of a second packet stream comprising erasure coded data generated from the packets of the first data packet streams;
transmitting, at the sender, packets of the second packet stream to a receiver;
reliably converting, at the receiver, packets of the second packet stream using erasure decoding into packets of the first data packet streams, and
transmitting, at the receiver, packets of the first data packet streams to the one or more destinations, wherein a packet count of the packets of the second packet stream generated and transmitted by the sender to ensure reliable conversion is based on feedback packets transmitted from the receiver to the sender.

2. The method of claim 1, further comprising transmitting the feedback packets from the receiver to the sender.

3. The method of claim 1, wherein a size for the packets of the first data packet streams varies among the packets and wherein a size for packets of the second data packet stream does not vary.

4. The method of claim 1, wherein a first packet of the first data packet stream comprises a first portion and a second portion, wherein the second data packet stream comprises at least a first packet of the second data packet stream and a second packet of the second data packet stream, and wherein the first portion is carried in the first packet of the second data packet stream and the second portion is carried in the second packet of the second data packet stream.

5. The method of claim 1, wherein a first packet of the second data packet stream comprises a first portion and a second portion, wherein the first data packet stream comprises at least a first packet of the first data packet stream and a second packet of the first data packet stream, and wherein the first portion corresponds to data of the first packet of the first data packet stream and the second portion corresponds to data of the second packet of the first data packet stream.

6. The method of claim 1, wherein converting at the sender comprises:
organizing, at the sender, data of the packets of the first data packet streams into a sequence of one or more data blocks, each block having a block identifier associated therewith and each block carrying identifying information about the packets of the first data packet streams carried in the block, wherein the packets of the first data packet streams vary in size; and
erasure encoding, at the sender, a data block of the one or more data blocks into a second sequence of packets for the data block, wherein packets of the second sequence of packets for the data block are interchangeable.

7. The method of claim 6, wherein organizing the data of the packets of the first data packet streams into the sequence of one or more data blocks comprises determining, at the sender, which data packets of the first data packet streams are included in a data block based on one or more timers.

8. The method of claim 7, wherein determining, at the sender, which data packets of the first data packet streams are included in a data block based on one or more timers, comprises:
initiating, at the sender, a first data block;
starting, at the sender, a timer when a first data packet arrives at the sender;
adding, at the sender, the first data packet to the first data block;
adding, at the sender, data packets that arrive at the sender to the first data block while the timer is running;
completing, at the sender, the first data block when the timer expires; and
initiating, at the sender, a second data block.

9. The method of claim 7, wherein determining, at the sender, which data packets of the first data packet streams are included in a data block based on one or more timers, comprises:
initiating, at the sender, a first data block;
starting, at the sender, a first timer and a second timer when a first data packet arrives at the sender;
adding, at the sender, the first data packet to the first data block;
determining, at the sender, whether a next data packet arrives or whether the second timer expires;
completing, at the sender, the first data block if the second timer expires before the next data packet arrives;
adding, at the sender, the next data packet to the first data block and restarting, at the sender, the second timer if the next data packet arrives before the second timer expires;
completing, at the sender, the first data block if the first timer expires; and
initiating, at the sender, a second data block.

10. The method of claim 1, wherein reliably converting at the receiver, comprises:
associating, at the receiver, the packets of the second data packet stream with one or more data blocks, each block having a block identifier associated therewith;
recovering, at the receiver, a data block of the one or more data blocks from packets associated with the data block from the second data packet stream using erasure decoding, wherein packets associated with a data block of the second data packet stream are interchangeable; and
extracting, at the receiver, packets of the first data packet streams from a recovered data block using identify information included in the data block.

11. A method of transmitting one or more first data packet streams from one or more source devices to one or more destination devices, the method comprising:
configuring, at the one or more source devices, transmission of packets of the first data packet streams to a sender device;
receiving, at the sender device, packets of the first data packet streams from the one or more source devices;
converting, at the sender device, packets of the first data packet streams into packets of a second data packet stream comprising erasure coded data generated from the packets of the first data packet streams;
transmitting, at the sender device, packets of the second data packet stream to a receiver device;
reliably converting, at the receiver device, the packets of the second data packet stream into packets of the first data packet streams, and
transmitting, at the receiver device, packets of the first data packet streams to the one or more destination devices, wherein the number of packets of the second data packet stream generated and transmitted by the sender device to ensure reliable conversion is based on feedback packets transmitted from the receiver device to the sender device.

12. The method of claim 11, wherein at least one of the source devices and the sending device are the same device.

13. The method of claim 11, wherein at least one of the destination devices and the receiving device are the same device.

14. A method of transmitting one or more first data packet streams from one or more sources to one or more destinations with reliability of transmission, wherein an explicit congestion notification field (ECN field) in packet headers of the packets of the first data packet stream are set to indicate ECN-Capable Transport (ECT), the method comprising:
configuring, at the one or more sources, transmission of packets of the first data packet streams to a sender;
receiving, at the sender, packets of the first data packet streams from the one or more sources;
determining, at the sender, a latency estimate of latency between the sender and receiver;
modifying, at the sender, packets of the first data packet streams to form modified packets, wherein a modified packet of the modified packets has its ECN field indicating congestion experienced (CE) in packets indicating network congestion if the latency estimate is larger than a target latency;
converting, at the sender, the modified packets of the first data packet streams into a second data packet stream comprising erasure coded data generated from the packets of the first data packet streams;
transmitting, at the sender, packets of the second packet stream to the receiver;
reliably converting, at the receiver, the received packets of the second data packet stream into packets of the first data packet streams, and
transmitting, at the receiver, the packets of the first data packet streams to the destinations.

15. The method of claim 14, wherein determining the latency estimate comprises:
determining, at the sender, an estimate of an RTT between the sender and receiver;
setting, at the sender, the latency estimate equal to the estimate of the RTT.

16. The method of claim 15, wherein modifying, at the sender, the ECN field to indicate congestion experienced (CE) in packets of the first data packet streams indicating network congestion if the latency estimate is larger than a target latency, comprises:
comparing, at the sender, an estimate of the RTT between the sender and receiver to a target latency and a maximum latency; and
setting, at the sender, the ECN field to indicate congestion experienced (CE) in a proportion of the packets of the first data packet streams indicating network congestion, wherein the proportion is based on a relationship between the estimate of the RTT, the target latency, and the maximum latency.

17. The method of claim 14, wherein setting the ECN to indicate CE in a packet is based on whether the sender detects packet loss in the second data packet stream.

18. A non-transitory computer-readable storage medium storing instructions,
which when executed by at least one processor of a computer system, causes the computer system to:
configure, at one or more sources, transmission of packets of one or more first data packet streams to a sender;
receive, at the sender, packets of the first data packet streams from the one or more sources;
convert, at the sender, packets of the first data packet streams into packets of a second packet stream comprising erasure coded data generated from the packets of the first data packet streams;
transmit, at the sender, packets of the second packet stream to a receiver;
reliably convert, at the receiver, packets of the second packet stream using erasure decoding into packets of the first data packet streams, and
transmit, at the receiver, packets of the first data packet streams to one or more destinations, wherein a packet count of a number of packets of the second packet stream generated and transmitted by the sender to ensure reliable conversion is based on feedback packets transmitted from the receiver to the sender.
